(19) United States
(12) Patent Application Publication
(10) Pub. No.: US 2026/0240350 A1
(43) Pub. Date: Aug. 20, 2026

(54) MULTI-CONDIMENT DISPENSING APPARATUS, SYSTEMS, AND RELATED METHODS

(71) Applicant: H. J. Heinz Company Brands LLC, Pittsburgh, PA (US)

(72) Inventors: Melanie Heckman, Chicago, IL (US); Maxine J. Roman, Chicago, IL (US); Connie Wong, Glenview, IL (US); Eleanor Joy Coffin, Indianapolis, IN (US); Brandon Michael Lacy, Indianapolis, IN (US); Andrew Brent Mendenhall, Mooresville, IN (US); Todd Christopher Midkiff, Noblesville, IN (US); Levi Daniel Roberts, Mooresville, IN (US); Isaac Newton Seals, Carmel, IN (US); Errol Jeffrey Naimon, Reno, NV (US)

(21) Appl. No.: 19/160,577

(22) PCT Filed: Feb. 27, 2024
(86) PCT No.: PCT/US2024/017445

§ 371 Date: Aug. 28, 2025

Related U.S. Application Data
(60) Provisional application No. 63/448,936, filed on Feb. 28, 2023.
(60) Provisional application No. 63/466,920, filed on May 16, 2023.
(60) Provisional application No. 63/466,928, filed on May 16, 2023.

(51) Int. Cl. A47G 19/18; B65D 83/682

(52) U.S. Cl. CPC A47G 19/183; B65D 83/682

(57) ABSTRACT

A condiment dispenser is provided that has a plurality of condiment supports each configured to position different types of condiment. The condiment dispenser has a dispensing head including a plurality of passages therethrough, with each passage of the plurality of passages including an inlet end and an outlet end. The condiment dispenser has a condiment receptacle receiving portion to receive a receptacle, the condiment receptacle receiving portion positioned adjacent the outlet ends of the plurality of passages of the dispensing head. The condiment dispenser includes a plurality of fluid transfer systems each connected to a condiment support of the plurality of condiment supports and a passage of the plurality of passages of the dispensing head. Each fluid transfer system is operable to transfer condiment from the condiment support to a corresponding passage of the dispensing head to dispense the condiment into the receptacle from the outlet end of the corresponding passage of the dispensing head.

### CROSS-REFERENCE TO RELATED APPLICATIONS

This application claims the benefit of U.S. Provisional Application No. 63/448,936, filed Feb. 28, 2023, U.S. Provisional Application No. 63/466,920, filed May 16, 2023, and U.S. Provisional Application No. 63/466,928, filed May 16, 2023 which are all hereby incorporated herein by reference in their entireties.

### FIELD

This disclosure relates to fluid dispensing and mixing devices and, in particular, to condiment mixing devices, systems, and methods.

### BACKGROUND

Restaurants often provide customers with one or more condiments for their food items. These condiments include, as examples, ketchup, mustard, mayonnaise, and barbeque sauce, as well as other condiments including particulate. Some restaurants provide large containers of one or more condiments along with a hand pump that is actuated to dispense the condiment to the user for use with their food. A separate condiment dispensing unit is provided for each type of condiment the restaurant offers to customers. Restaurants thus must separately service and clean each separate condiment dispensing unit.

Customers are more frequently seeking to have combinations of condiments, flavorings and the like. In this regard, if a user wants to combine ketchup with mayonnaise, the user would go to a first dispenser and then a second dispenser, ultimately having to mix the condiments, such as with a spoon. This can be cumbersome and also result in messes for the consumer. Additionally, providing a wide selection of condiments for users to choose from in a restaurant generally requires large spaces to accommodate the number of condiment dispensers.

Instead of providing multiple separate dispensers, a multi-condiment dispenser can be provided. However, for the sake of cleanliness and to avoid cross-contamination between the different condiments, each condiment or flavoring is provided with a separate discharge line. Therefore, the user may retrieve a first condiment, then a second condiment, and then manually mix the condiments together. Thus, a condiment dispenser is desired that is capable of combining and mixing different condiment components, such as condiment bases, flavorings, and the like, resulting in a combined, customized condiment for the user while remaining clean and avoiding cross-contamination between the different condiments.

### BRIEF DESCRIPTION OF THE DRAWINGS

FIG. 1A is a top perspective view of a condiment dispenser.

FIG. 1B is a bottom perspective view of the condiment dispenser of FIG. 1A.

FIG. 2A is a perspective view of the condiment dispenser of FIG. 1A shown with a front door removed from a housing body of the condiment dispenser.

FIG. 2B is a perspective view of the condiment dispenser of FIG. 1A shown without the distribution tubes and with pouch support trays withdrawn from the housing body.

FIG. 3A is a front perspective view of an internal support structure of the condiment dispenser of FIG. 1A supporting upper, middle, and lower racks of pouch support trays.

FIG. 3B is a rear perspective view of the internal support structure of FIG. 3A.

FIG. 4A is a top perspective view of a portion of the internal support structure of FIG. 3A supporting the middle rack of pouch support trays, drip trays, and pumps.

FIG. 4B is a top perspective view of the portion of the internal support structure of FIG. 4A illustrating a pouch support tray and pump separated from the internal support structure.

FIG. 4C is a bottom perspective view of the portion of the internal support structure of FIG. 4A illustrating the pouch support tray and the pump separated from the internal support structure.

FIG. 5A is a top perspective view of an upper portion of the internal support structure of FIG. 3A supporting the upper rack of pouch support trays, drip trays, and pumps.

FIG. 5B is a top perspective view of the upper portion of the internal support structure of FIG. 5A illustrating a pouch support tray and pump separated from the internal support structure.

FIG. 5C is a side elevation view of the upper portion of the internal support structure of FIG. 5A with a pouch support tray separated from the internal support structure.

FIG. 5D is a bottom perspective view of the upper portion of the internal support structure of FIG. 5A with the pump separated from the internal support structure.

FIG. 5E is a perspective view of the pouch support tray of the upper rack of FIG. 5A.

FIG. 6A is a top perspective view of a dispensing head of the condiment dispenser of FIG. 1A.

FIG. 6B is a bottom perspective view of the dispensing head of FIG. 6A.

FIG. 7 is a cross-sectional view of the dispensing head of FIG. 6A and a cup receiver, a mixer, and a cup.

FIG. 8 is a cross-sectional view of the cup receiver and cup of FIG. 7 illustrating a suction tube and a vacuum chamber formed by the cup receiver and cup.

FIG. 9 is a cross-sectional view of the dispenser head taken across line 9 -9 of FIG. 6A.

FIG. 10A is a rear view of the front door of the condiment dispenser of FIG. 1A including an agitator system and a vacuum system.

FIG. 10B is a perspective view of the vacuum system of the condiment mixing apparatus of FIG. 1A.

FIG. 10C is a top perspective, exploded view of the agitator system of FIG. 10A.

FIG. 10D is a bottom perspective, exploded view of the agitator system of FIG. 10A.

FIG. 11A is a front perspective view of a lift system of the condiment dispenser of FIG. 1A to raise and lower the dispensing head.

FIG. 11B is a side view of the lift system of FIG. 11A.

FIG. 11C is a rear perspective view of the lift system of FIG. 11A with the dispensing head separated from the lift system.

FIG. 12 is a schematic diagram of various electronic components of the condiment dispenser of FIG. 1A and associated system.

FIG. 13 is a flow diagram of an example method of operation by the condiment dispenser of FIG. 1A to dispense and mix condiment.

FIG. 14A-14F illustrate examples of graphical user interface screens that are presented to the user when operating the condiment dispenser of FIG. 1A.

FIG. 15A-15D illustrate examples of graphical user interface screens that are presented to the user when servicing the condiment dispenser of FIG. 1A.

FIG. 16 is a top perspective view of a condiment dispenser according to another embodiment.

FIG. 17A is a perspective view of the condiment dispenser of FIG. 16 shown with a front door removed from a housing body of the condiment dispenser.

FIG. 17B is a perspective view of the condiment dispenser of FIG. 16 shown with the front door removed and with pouch support trays withdrawn from the housing body.

FIG. 18 is a perspective view of a shelf of the condiment dispenser of FIG. 16 having weight sensors to support the pouch support trays, FIG. 18 illustrating a pouch support tray and weight plates separated from the shelf.

FIG. 19A is a perspective view of is a front perspective view of a lift system of the condiment dispenser of FIG. 16 to raise and lower a dispensing head.

FIG. 19B is an exploded view of the dispensing head of FIG. 19A.

FIG. 19C is a cross-sectional view of the dispensing head of FIG. 19A taken across lines 19C-19C of FIG. 19A.

FIG. 19D is a cross-sectional view of the dispensing head of FIG. 19A taken across lines 19D-19D of FIG. 19A.

### DETAILED DESCRIPTION

A condiment dispenser is provided that is able to dispense and mix multiple types of condiments (e.g., mayonnaise and sriracha) to the user. The condiment dispenser includes a housing containing multiple condiment components. The condiment dispenser has multiple outlets with each outlet dispensing one of the plurality of condiment components. The outlets are positioned to dispense the condiments into a receptacle (e.g., a cup) positioned at a condiment receiving portion of the condiment dispenser which is positioned adjacent the outlets. The condiment dispenser receives a user selection, for example, via a user interface (e.g., a touchscreen display) of one, two, or more condiments to be dispensed from the outlets and mixed. The condiment receptacle receiving portion receives the receptacle to be filled and the condiment dispenser is operable to dispense the selected condiments into the receptacle from the outlets. The condiment dispenser further includes an agitator operable to agitate the receptacle, such as to mix the selected condiments dispensed from the outlets into the receptacle.

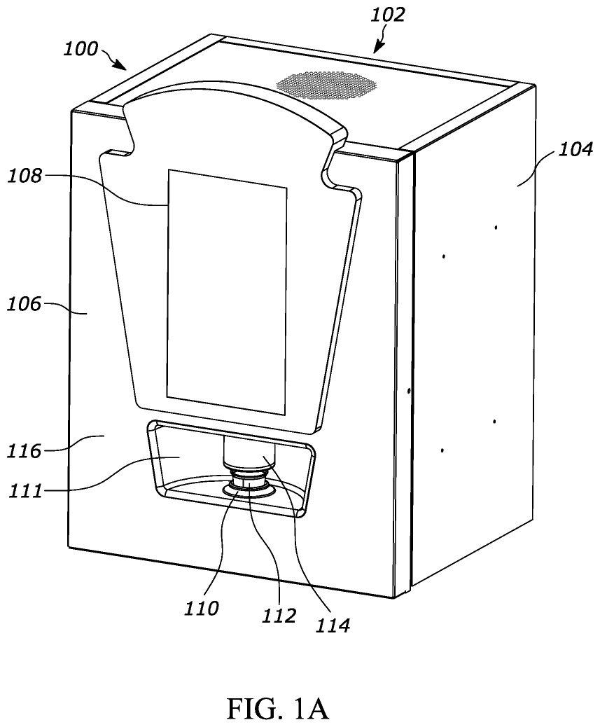

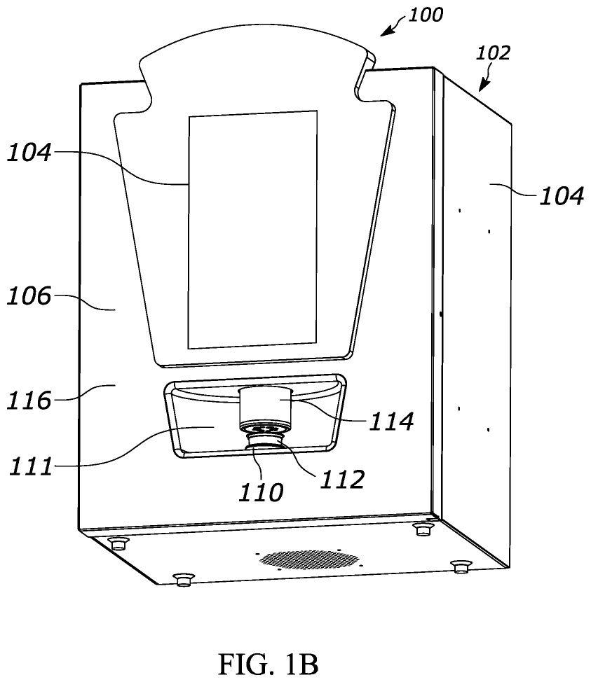

With respect to FIGS. 1A-1B, a condiment dispenser 100 is provided that includes a housing 102 having a housing body 104 and front portion such as door 106. The door 106 includes a user interface 108, such as a touchscreen display that may be used to operate the condiment dispenser 100, for example, to select the condiments to be dispensed and mixed together as discussed in further detail below.

The door 106 includes a condiment receptacle receiving portion such as cup holder 110 where a receptacle such as a cup 112 may be positioned to be filled with condiment. The size of the cup holder 110 can be varied to accommodate different sized cups 112. For example, in some forms the cup 112 may be 2.5 oz., 4 oz., 6 oz., 8 oz., and the like. The condiment dispenser 100 may include a dispensing head 114 through which condiment may be dispensed into the cup 112 in the cup holder 110. The door 106 may include a pocket 111 that is recessed from a front surface 116 of the door 106. The cup holder 110 may be positioned in the pocket 111 and below the dispensing head 114 to position the cup 112 to be filled with condiment. The dispensing head 114 may extend into the pocket 111 or be positioned above the pocket 111 to dispense condiment into the cup 112. As discussed below, the dispensing head 114 may be raised above and lowered into the pocket 111 to position the dispensing head 114 above the cup holder 110 and cup 112 to dispense condiment into the cup. Lowering the dispensing head 114 to be closer to the cup 112 may aid to ensure that the condiment is not spilled outside of the cup 112. In other forms, the cup holder 110 may be raised and lowered relative to the dispensing head 114.

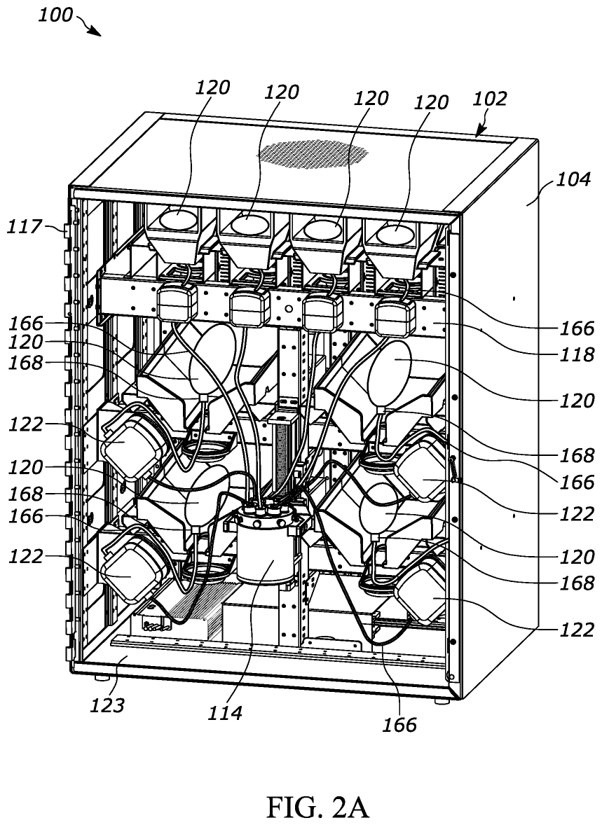

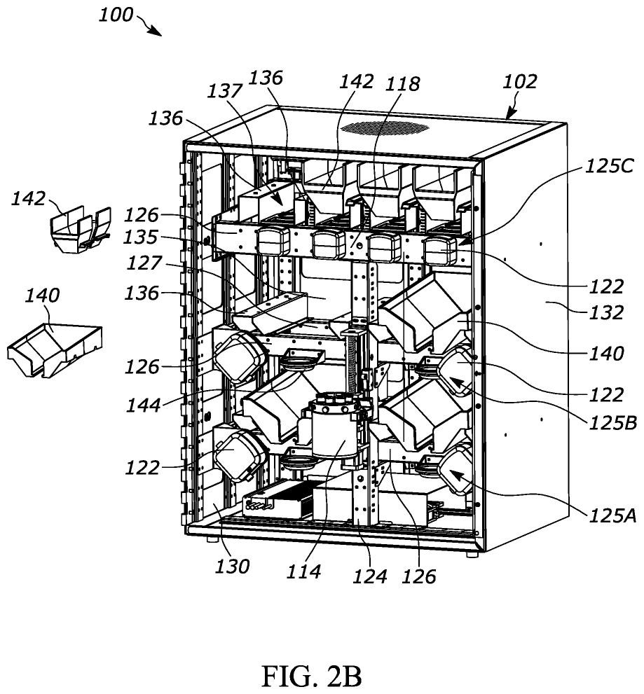

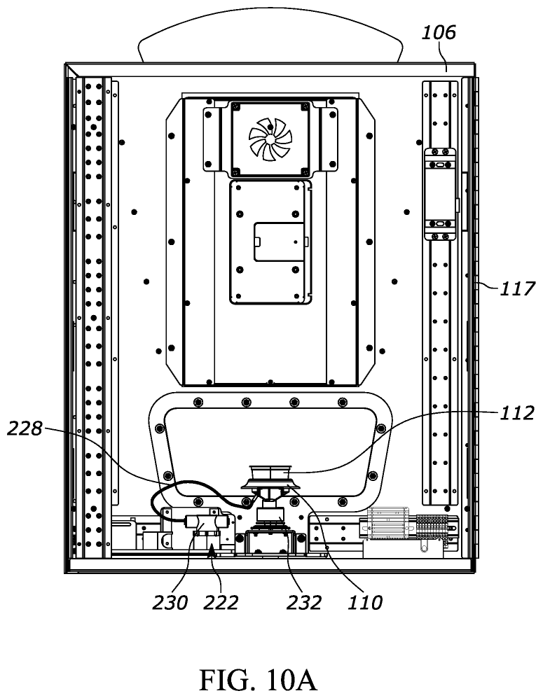

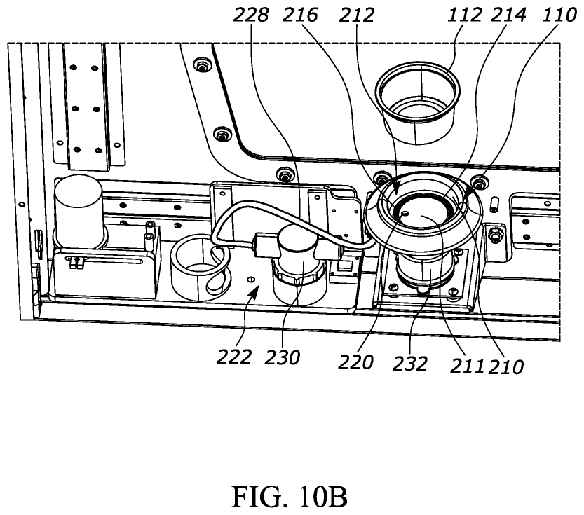

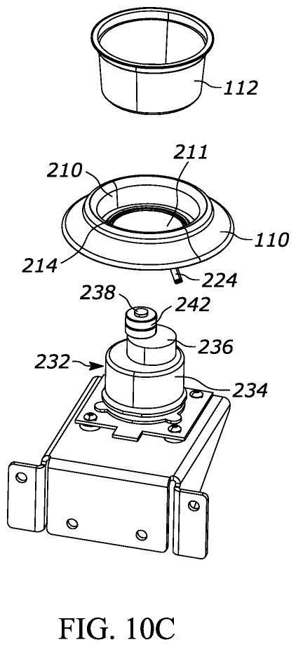

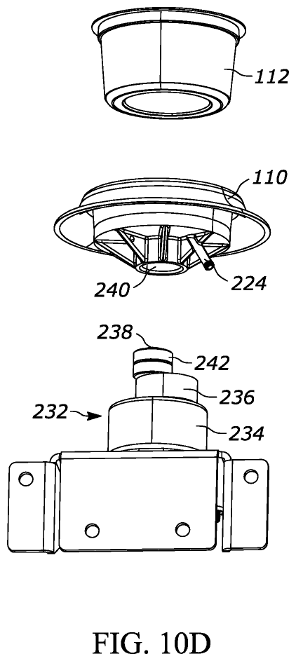

The door 106 may be attached to the housing body 104 with a hinge 117 (see FIGS. 2A and 10A) that permits the door 106 to be opened to access the interior of the housing 102. For example, the door 106 may be opened to replace or refill the condiment of the condiment dispenser 100 and/or to perform maintenance (e.g., clean) the condiment dispenser 100.

With respect to FIGS. 2A-2B, the condiment dispenser 100 is shown with the door 106 removed to show the interior of the condiment dispenser 100. The condiment dispenser 100 includes an internal support frame 118 that supports condiment containers such as condiment pouches 120, the fluid transfer systems 121 including pumps 122, and the dispensing head 114. The internal support frame 118 may include multiple levels of racks to support multiple condiment pouches 120 while minimizing the footprint of the condiment dispenser 100, for example, on a countertop. The condiment pouches 120 are connected to tubes 166 that extend to the pumps 122 and from the pumps 122 to the dispensing head 114. The pumps 122 may be operated to draw condiment from the condiment pouches 120 and to pump the condiment toward the dispensing head 114 to dispense the condiment into the cup 112 positioned in the cup holder 110. The dispensing head 114 may be positioned at a lower end of the condiment dispenser 100 when dispensing condiment to promote gravimetric dispensing from the condiment pouches 120 to the dispensing head 114 to aid the pumps 122 in moving the condiment through the tubes 166.

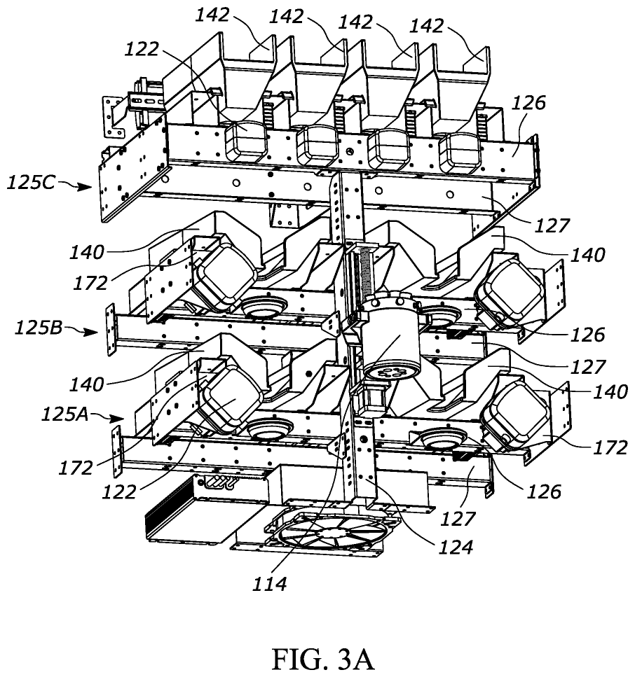

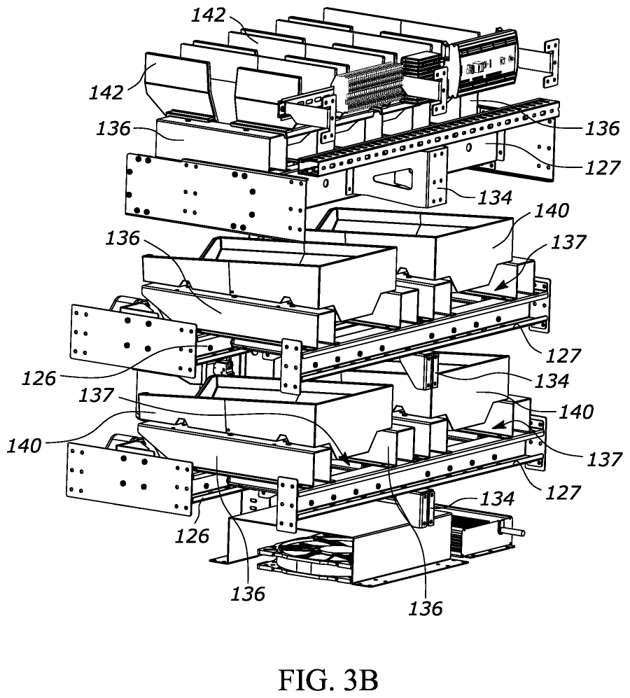

With reference also to FIGS. 3A-3B, the internal support frame 118 has front and rear lateral supports 126, 127 that form shelves or racks for supporting the condiment pouches 120 thereon. In the form shown, the internal support frame 118 includes three levels of racks including a lower rack 125A, a middle rack 125B, and an upper rack 125C. While the embodiment shown has three levels of racks, in other forms, the internal support frame 118 may include fewer or more levels or racks to provide support for the desired number of condiment containers and/or based on the dimensions of the housing 102 of the condiment dispenser 100.

The lateral supports 126, 127 may extend between and be secured to the opposing sidewalls 130, 132 (see FIG. 2B) of the housing body 104. The rear lateral supports 127 may further be secured to the rear wall 135 (see FIG. 2B) of the housing body 104 by a support bracket 134 (see FIG. 3B). The internal support frame 118 includes a longitudinal support 124 extending vertically from a bottom wall 123 (see FIG. 2A) of the housing 102 to the front lateral support 126 of the upper rack 125C. The front lateral supports 126 of the lower and middle racks 125A, 125B are secured to the longitudinal support 124.

The internal support frame 118 may also include support bars 136 that extend from the front lateral support 126 to the rear lateral support 127. Pairs of support bars 136 form docks 137 for receiving the condiment pouches 120 loaded into the condiment dispenser 100. The condiment dispenser 100 may include pouch support trays 140, 142 that receive a condiment pouch 120 (see FIG. 2A). The docks 137 of the lower rack 125A and middle rack 125B may be larger than the docks 137 of the upper rack 125C and sized to receive a larger sized pouch support tray 140. The larger pouch support tray 140 may receive and support a larger sized condiment pouch, such as a pouch containing a base condiment, condiment that is dispensed in larger volumes, or consumed rapidly. Examples of base condiments include ketchup, ranch dressing, barbeque, Heinz® 57 sauce, mayonnaise, aioli, mustard, relish, sweet and sour, taco sauce, tartar sauce, marinara, buffalo, salsa, chili sauce, cocktail sauce, burger sauce, and the like. The docks 137 of the upper rack 125C may be smaller than those of the lower and middle racks 125A, 125B and sized to receive a smaller sized pouch support tray 142. The smaller pouch support tray 140 may receive and support a smaller sized condiment pouch, such as a pouch containing a mix-in or accent flavoring, condiment dispensed in smaller volumes, or consumed more slowly. Examples of accent flavors include jalapeno, buffalo, chipotle, mango, curry, garlic, caramelized onion, cilantro lime, honey, sriracha, teriyaki, lemon pepper, jerk, parmesan, malt vinegar, avocado, gochujang, Cajun, bacon, smoke, ghost pepper, and the like.

The pouch support trays 140, 142 may be positioned in a corresponding dock 137 on the support bars 136. The pouch support trays 140, 142 may support a condiment pouch 120 positioned therein. With respect to FIG. 2B, the pouch support trays 140, 142 may be removed from the docks 137, for example, to be loaded with a condiment pouch. The pouch support trays 140, 142 may be inserted into the docks 137 along the support bars 136, for example, to load the condiment pouch into the condiment dispenser 100. The support bars 136 and/or pouch support trays 140, 142 may include interlocking features to secure the pouch support tray 140, 142 to their proper position along the support bars 136 as discussed below.

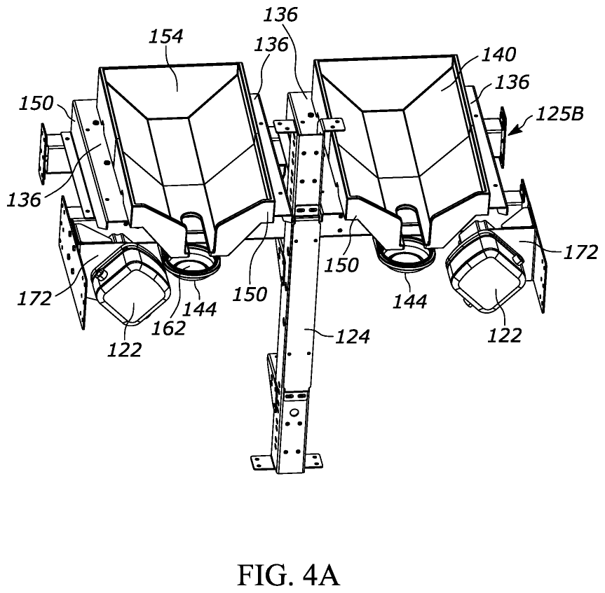

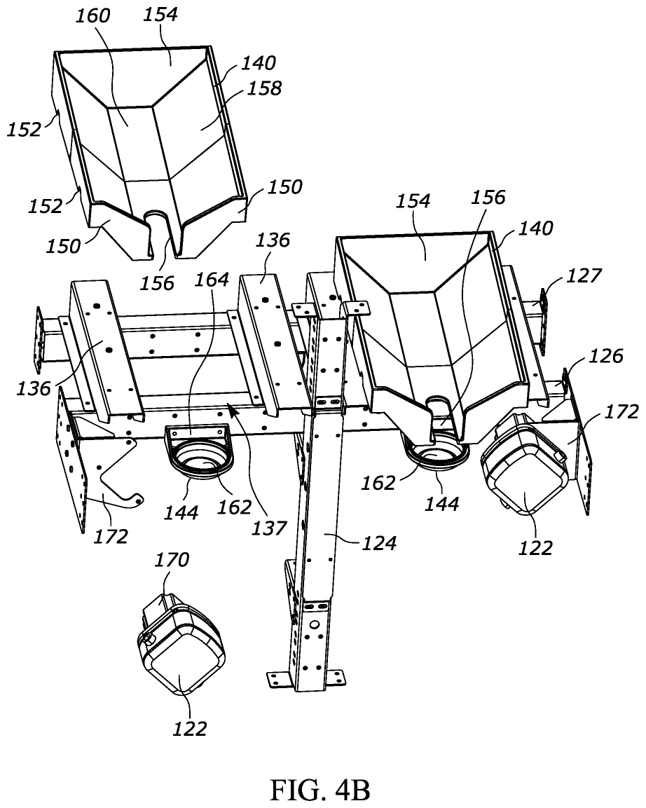

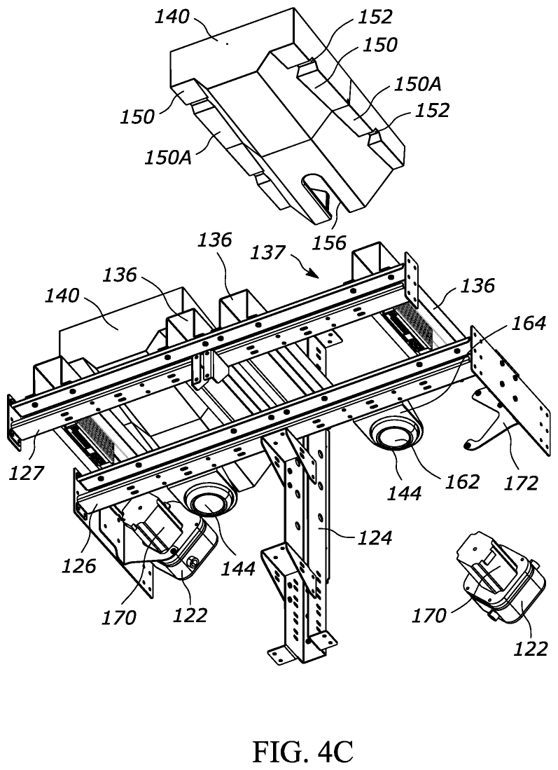

With respect to FIGS. 4A-4C, the middle rack 125B of the condiment dispenser 100 is shown supporting two pouch support trays 140, drip trays 144, and pumps 122. The lower rack 125A is similar to the middle rack 125B such that the discussion of similar features of the lower rack 125A will not be repeated. The pouch support trays 140 may include flanges 150 sized to rest on the support bars 136 of the dock 137 when the pouch support tray 140 is inserted into the dock 137. The flanges 150 may include notches 152 that may receive corresponding protrusions of the support bars 136 when the pouch support tray 140 is properly positioned on the support bars 136. The protrusions and notches 152 may aid to align and properly position the support tray 140 on the support bars 136. The protrusions and notches 152 may further aid to inhibit the pouch support trays 140 from unintentionally sliding or moving substantially relative to the support bars 136 to aid in keeping the pouch support tray 140 properly positioned on the support bars 136.

The pouch support trays 140 may include an internal support surface 154 configured to direct the condiment in the pouch toward an opening or slot 156. Directing the condiment in the pouch toward the slot 156 aids in more fully emptying the condiment from the pouch. The internal support surface 154 may include angled sidewalls 158 that slope toward a base 160 to direct the condiment toward the base 160. The base 160 may also be sloped downward toward the slot 156 to direct the condiment toward the slot 156 to empty the condiment in the associated tube 166. In the embodiment shown, bottom surfaces 150A (see FIG. 4C) of the flanges 150 of the pouch support tray 140 extend at an angle relative to the base 160 such that when the flanges 150 rest on the support bars 136 of the dock 137, the base 160 is sloped toward the slot 156. In other embodiments, the support bars 136 may be sloped to orient the pouch support tray 140 such that the base 160 is sloped. The slot 156 may extend along a sidewall of the tray 140 from the top to the bottom enabling the tube 166 to be connected to the pouch 120 outside of the tray and then loaded together into the tray 142 by passing the tube 166 along the slot 156 rather than feeding the tube 166 through a hole.

The drip tray 144 includes a basin portion 162 and a bracket portion 164. The bracket portion 164 is used to mount the drip tray 144 to the front lateral support 126. Fasteners may be extended through the bracket portion 164 and into the front lateral support 126 to secure the drip tray 144 to the internal support frame 118. The bracket portion 164 supports the basin portion 162 such that the basin portion 162 is beneath the slot 156 of the pouch support tray 140 when the pouch support tray 140 is installed in the condiment dispenser 100. As shown in FIG. 2A, the condiment pouches 120 are connected to tubes 166 by a connector 168. The connector 168 may be positioned within or above the slot 156 of the pouch support tray 140 and above the basin portion 162 of the drip tray 144 such that condiment that leaks from the connection between the connector 168 and the condiment pouch 120 or tube 166 drips and/or falls into the basin portion 162 of the drip tray 144. Additionally, where the internal support surface 154 slopes toward the slot 156, any condiment that is on the internal support surface 154 may flow toward the slot 156 and fall into the drip tray 144. The drip tray 144 therefore may be used to catch any condiment that leaks from the condiment pouch 120 to prevent the condiment from dripping or flowing to another part of the condiment dispenser 100. The drip tray 144 may be emptied and/or cleaned periodically.

A fluid transfer system 121 may be associated with each condiment pouch 120 and operable to transfer fluid from the condiment pouch 120 to the dispensing head 114 to be dispensed into the cup 112. The fluid transfer system 121 includes the pump 122, a motor 170 configured to drive the pump 122, and the tube 166 through which the condiment is pumped from the condiment pouch 120 to the dispensing head 114. As shown in FIG. 2A, the tube 166 extends from the condiment pouch 120 to the pump 122 and from the pump 122 to the dispensing head 114. The pump 122 may be driven by the motor 170 to move the condiment from the condiment pouch 120 to the dispensing head 114. The motor 170 and pump 122 may be connected to the sidewall 130 of the housing body 104 and/or the lateral support 126 by a support bracket 172. The pump 122 may be a peristaltic pump through which the tube 166 extends. The pump 122 may be driven by the motor 170 and transport the condiment through the tube 166 without coming into contact with the condiment. The tubes 166 may be may suitable for condiments of any variety to flow through and be formed of a flexible food-safe material such as a silicone or rubber. The tubes 166 may have an internal diameter of 3-9 mm and an external diameter of 4-20 mm. The tubes 166 may be made of a flexible material that may be compressed by the peristaltic pumps 122 to draw condiment toward the pump and urge condiment from the pump 122. The tubes 166 may have a durometer selected to optimize the flow of condiment therethrough and to inhibit forming of a vacuum therein. The diameter, length, and/or durometer of the tube 166 may be selected based on the type of condiment flowing therethrough to control the flow of the condiment therethrough. The tube 166 may periodically be cleaned or replaced with a new tube 166, for example, when a new condiment pouch 120 is loaded into the condiment dispenser 100.

Other types of pumps 146 may also be used the pump the condiment from the condiment pouch 120 to the dispensing head 114. For example, the pump 122 may be made of food-safe materials and configured to directly contact the condiment to pump the condiment toward the dispensing head 114. For instance, the pump 122 may be a disposable pump that is removably connected to the motor 170. The pump 122 may periodically be disposed and replaced or cleaned, for instance, when the condiment pouch 120 is replaced. Alternatively, the pump may have a replaceable pump head that comes in contact with condiment.

In other embodiments, the condiment may be pressed out of a condiment container by a plunger. The plunger may be driven by a motor to press against the condiment to force the condiment to flow out of the condiment container into the tube 166 connected to the condiment container and to the dispensing head 114.

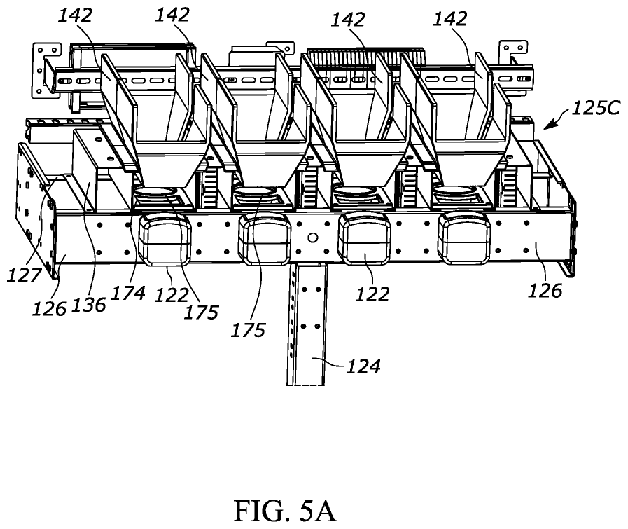

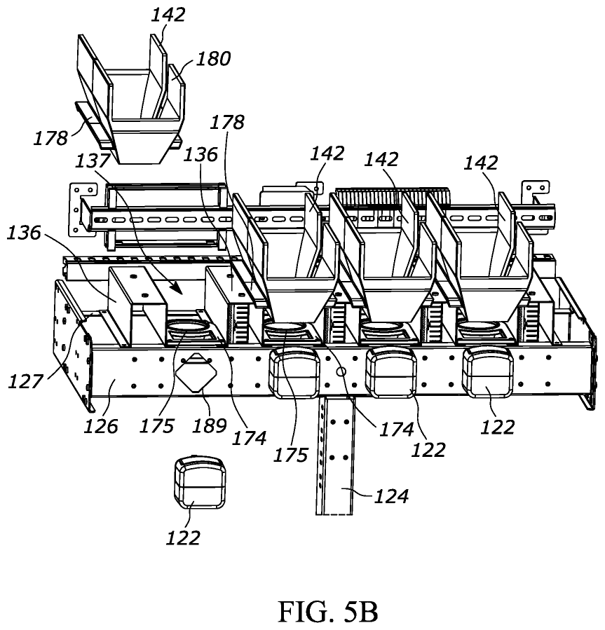

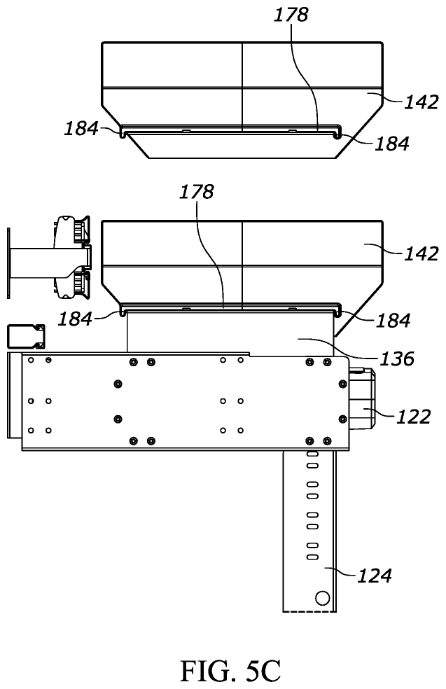

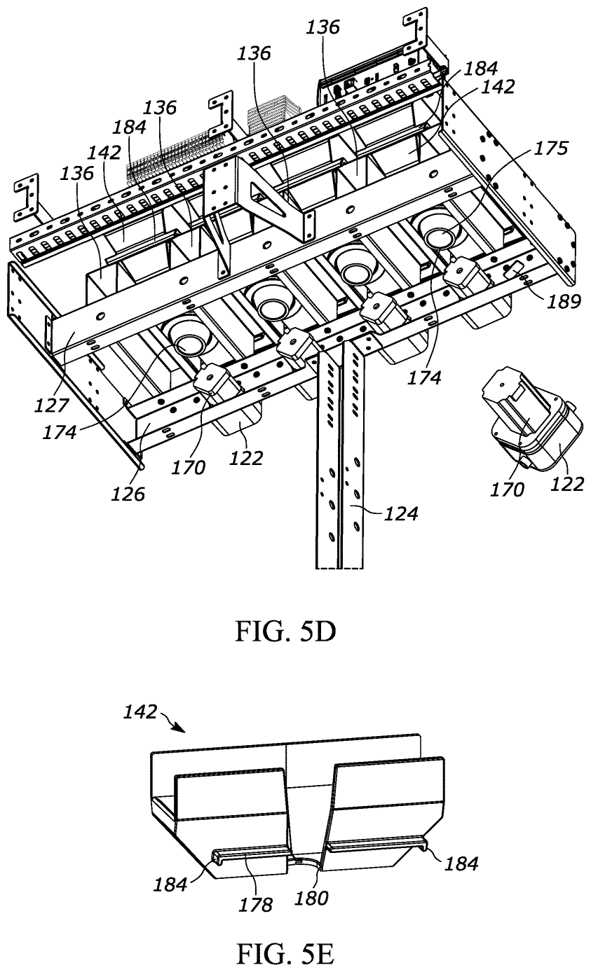

With respect to FIGS. 5A-5D, the upper rack 125C of the condiment dispenser 100 is shown supporting four pouch support trays 142, drip trays 174, and pumps 122. The upper rack 125C may support four support trays 142 because the pouch support trays 142 are smaller and sized to hold smaller sized pouches. The smaller pouch support trays 142 may support smaller condiment pouches 120. Positioning the smaller pouch support trays 142 and condiment pouches 120 at the upper end of the condiment dispenser 100 may reduce the weight to be lifted by an installer to position the pouch support tray 142 in the dock 137 of the upper rack 125C. Additionally, the condiment pouches 120 in the upper rack 125C may be less viscous and thus more readily flow through a longer tube 166 than, for example, a thicker, more viscous base condiment.

It should be appreciated that any number of different pouches, condiments, flavors, and the like may be used. For example, while shown in the figures as having four support trays 140 and four support trays 142, any number of different support trays 140,142 can be used for various numbers of condiments, flavors, and the like. In some forms, ten support trays 140 and ten support trays 142 could be used. In other forms, support trays 140,142 could be positioned in a separate unit or machine so as to expand the number of condiments and flavors. For example, the condiments and flavor pouches could be positioned in a cabinet or separate unit, but connected to the dispenser 100 to be dispensed therethrough.

Each of the pouch support trays 142 are positioned on a pair of adjacent support bars 136 that form docks 137 for the pouch support trays 142. With reference also to FIG. 5E, the pouch support tray 142 includes flanges 178 that rest on the support bars 136 when the pouch support tray 142 is inserted into the dock 137. The ends of the flanges 178 may have hooks 184 that wrap around the ends of the support bars 136 (see FIG. 5C) to inhibit the pouch support tray 142 from unintentionally sliding relative to the support bars 136. The pouch support tray 142 may include an opening or slot 180 through which the tube 166 may extend from the pouch 120 within the pouch support tray 142 to the pump 122. The slot 180 may extend along a sidewall of the tray from the top to the bottom enabling the tube 166 to be connected to the pouch 120 outside of the tray and then loaded together into the tray 142 by passing the tube 166 along the slot 180. In the form shown, the slot 180 is centrally positioned in the pouch support tray 142.

The drip tray 174 may extend from the front lateral support 126 toward the rear lateral support 127 beneath the pouch support tray 142. The drip tray 174 may be secured to the front lateral support 126 via fasteners and may rest on flanges of the support bars 136 extending between the front and rear lateral supports 126, 127. The drip tray 174 may include a basin portion 175 positioned below the slot 180 to catch any condiment that leaks from the condiment pouch 120 and/or the connection between the connector 168 and the tube 166 or condiment pouch 120. The pouch support tray 142 may have internal support walls 182 that slope toward the slot 180 to direct condiment toward the slot 180 to aid in more fully emptying the condiment pouch 120.

As shown in FIG. 2A, tubes 166 extend from the condiment pouches 120 of the pouch support trays 142 to the corresponding pump 122 and from the pump 122 to the dispensing head 114. The pump 122 may be driven by a motor 170 to move the condiment from the condiment pouch 120 to the dispensing head 114. The motor 170 and pump 122 may be connected to and supported by the front lateral support 126. The front lateral support 126 of the upper rack 125C may include an opening 189 through which the motor 170 may extend when the pump 122 and motor 170 are mounted to the front lateral support 126. The pump 122 may be a peristaltic pump through which the tube 166 extends. The pump 122 may be driven by the motor 170 and transport the condiment through the tube 166 without coming into contact with the condiment. The diameter, length, and/or durometer of the tube 166 may be selected based on the type of condiment flowing therethrough to control the flow of the condiment therethrough as discussed above. The tube 166 may periodically be cleaned or replaced with a new tube 166, for example, when a new condiment pouch 120 is loaded into the condiment dispenser 100. The components in the system, including, but not limited to, the tubes, pumps, dispensing head, and the like may all be cleaned in place. In this regard, a cleaning components may be incorporated such that the parts do not need to be removed to be cleaned. In some forms, the components may be removed and cleaned, such as in a dishwasher. As discussed above, other types of pumps may also be used to pump the condiment from the condiment pouch 120 to the dispensing head 114.

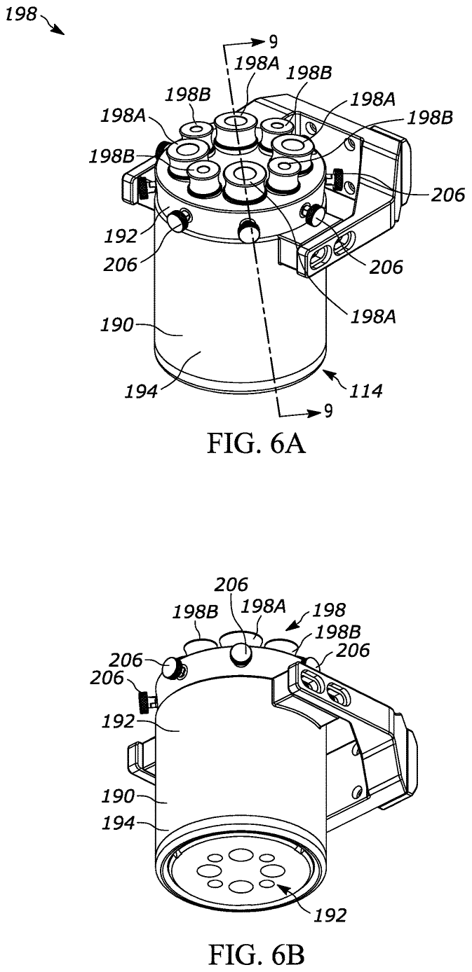

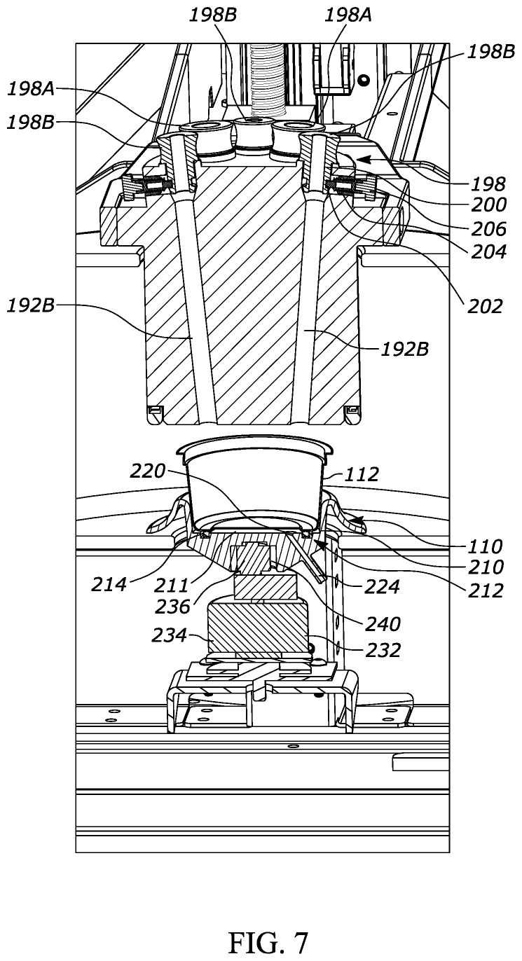

With respect to FIGS. 6A-6B, the dispensing head 114 is shown. It should be appreciated that, in some forms, the various condiments are not mixed or otherwise come into contact with one another in the dispensing head. Instead, only after being dispensed from the dispensing head will the condiments contact one another. The dispensing head 114 has a body 190 defining several openings 192 therethrough that extend from an inlet end 194 to an outlet end 196. The tubes 166 are connected to the openings 192 to transfer the condiment from the condiment pouches 120 to the dispensing head 114. The ends of the tubes 166 may be secured to the inlet end 194 by connectors 198. With reference also to FIG. 7, the connectors 198 have a tubular body 200 defining an opening into which an end of the tube 166 may be inserted. The connector 198 may be a quick connect/disconnect form such that tubes may be quickly inserted and removed. The connector 198 may be made of an elastomeric material, such as a rubber. The tube 166 may be secured in the connector 198 by a friction fit connection between the tube 166 and the tubular body 200 of the connector 198. The connector 198 may also be removably connectable to the body 190 of the dispensing head 114. The connector 198 may form a fluid tight connection with the tube 166 and the body 190 to inhibit condiment from leaking therebetween.

As shown in FIG. 7, an end of the connector 198 may include recessed portion or annular groove 202. The inlet end of the body 190 of the dispensing head 114 includes radially extending openings 204 into which a fastener 206 may be extended. The fastener 206 may be a spring-loaded peg mounted in the radially extending opening 204 of the body 190 that is biased radially inward. When the connector 198 is inserted into the dispenser head body 190, the fastener 206 may be biased radially inward by the spring until an end of the fastener 206 is within the annular groove 202 of the connector 198. With the fastener 206 in the groove 202 (as shown in FIG. 7), the fastener 206 inhibits the connector 198 from being withdrawn from the dispensing head body 190. To connect or disconnect the connector 198 and the tube 166 to or from the dispensing head body 190, the fastener 206 may be drawn radially outward against the biasing force of the spring until the end of the fastener is withdrawn from the annular groove 202 to permit the connector 198 to be inserted or withdrawn from the dispenser head body 190. In other forms, the fastener 206 may have a threaded shaft and the radially extending opening 204 of the body 190 may be threaded. The fastener 206 may be rotated to move the fastener 206 radially relative to the body 190 to connect or disconnect the connector 198 from the body 190. In other forms, the connectors 198 may be configured to snap into the openings 192 of the body 190. In still other forms, the tubes 166 are inserted into the openings 192 of the body 190 of the dispensing head 114 and no connectors are used.

The dispensing head 114 may include openings 192 and connectors 198 of different sizes including larger openings 192A (see FIG. 9) for use with the larger connectors 198A and smaller openings 192B (see FIG. 7) for use with smaller connectors 198B. With respect to FIG. 9, a cross-sectional view of the dispensing head 114 is provided showing the larger openings 192A extending through the dispensing head 114. The larger openings 192A and connectors 198A may be connected to tubes 166 that extend from a condiment pouch 120 including a condiment dispensed in a relatively high volume, for example, a base condiment such as those in the lower and middle racks 125A, 125B. With respect to FIG. 7, the smaller openings 192B and connectors 198B may be connected to tubes 166 that extend from a condiment pouch 120 including condiment dispensed in a relatively low volume, for example, a mix-in or accent flavoring such as those in the upper rack 125C. The tubes 166 connected to the smaller connectors 198B may also have a smaller diameter than those connected to the larger connectors 198A. The diameter of the tubes 166, connectors 198, and openings 192 of the dispensing head 114 may be sized to achieve a desired flow rate of condiment therethrough.

When the pumps 122 are operated, the pumps 122 drive the condiment through the tubes 166 and into the openings 192 at the inlet end 194 of the dispenser body 190. The condiment is forced along the openings 192 to the outlet end 196 where the condiment is dispensed into the cup 112 positioned below the openings 192 at the outlet end 196. As shown, the openings 192A, 192B may angle inward toward one another as they extend from the connectors 198 to the outlet openings. Angling the openings 192 toward one another may concentrate the openings at the outlet end 196 of the dispensing head 114 with the openings at the outlet end 196 being in closer proximity to one another than at the inlet end 194. This centers the outlet openings over a cup 112 and reduces the size of the cup 112 needed to receive condiment from all of the outlet openings. In some forms, the diameter of the opening 192 may changes, such as increase and/or decrease as it extends from the inlet end to the outlet end. Changes in diameter may be used to help reduce dripping.

To inhibit the condiment from unintentionally leaking or dripping out of the dispensing head 114, the condiment dispenser 100 may operate the pumps 122 in the reverse direction to draw condiment away from the openings 192 of the dispensing head 114. For example, after the condiment dispenser 100 has completed a dispensing cycle, the condiment dispenser 100 may cause the motors 170 to turn the pumps 122 in the reverse direction. Additionally or alternatively, the diameter of the openings 192 at the outlet end 196 of the dispensing head 114 may be reduced to inhibit the condiment from passing therethrough without force applied to the condiment by the pumps 122. Additionally or alternatively, the ends of the openings 192 at the outlet end 196 of the dispensing head 114 may step horizontally to inhibit condiment from dripping out of the dispensing head 114. Having a horizontal step in the flow path at the end of the openings 192 may, for example, reduce the possibility of the condiment dripping or falling out of the opening 192 compared to the opening 192 being straight and substantially vertical. In some forms, a valve (not shown) may be included at some point along the opening 192 to help prevent dripping. For example, a valve may be positioned near the outlet end.

With respect to FIGS. 1A and 7-8, the cup holder 110 is positioned below the outlet end 196 of the dispensing head 114. The cup holder 110 includes a sidewall 210 extending from a bottom wall 211 forming a recess 212 sized to receive the cup 112. The sidewall 210 may be sized such that the sidewall 210 engages a portion of the cup 112 inserted therein to securely hold the cup 112, for example, by a friction fit. In some forms, the cup holder 110 includes protrusions extending inward from the sidewall 210 into the recess 212. The protrusions may be biased radially inward to engage the cup 112 when inserted therein. Insertion of the cup 112 may deflect the protrusions outward while the protrusions remain biased against the cup 112 to retain the cup 112 in the recess 212. In some forms, the cup 112 may snap into the cup holder 110 to secure the cup 112 in the cup holder 110. For example, the cup holder 110 may have deflectable retention arms with barbed tips that engage the rim of the cup 112 when inserted therethrough. As another example, the cup holder 110 may include bands that may be positioned over the top of the cup 112 to hold the cup 112 on the cup holder 110.

With reference also to FIGS. 10A-10D, additionally or alternatively, the cup holder 110 may hold the cup 112 within the cup holder 110 using suction. The bottom wall 211 of the cup holder 110 may include an opening 220 fluidly connected to a vacuum system 222. The vacuum system 222 may be operated to suck air through the opening 220 to create a vacuum in the cup holder 110 and to draw a cup 112 positioned in the recess 212 toward the bottom wall 211.

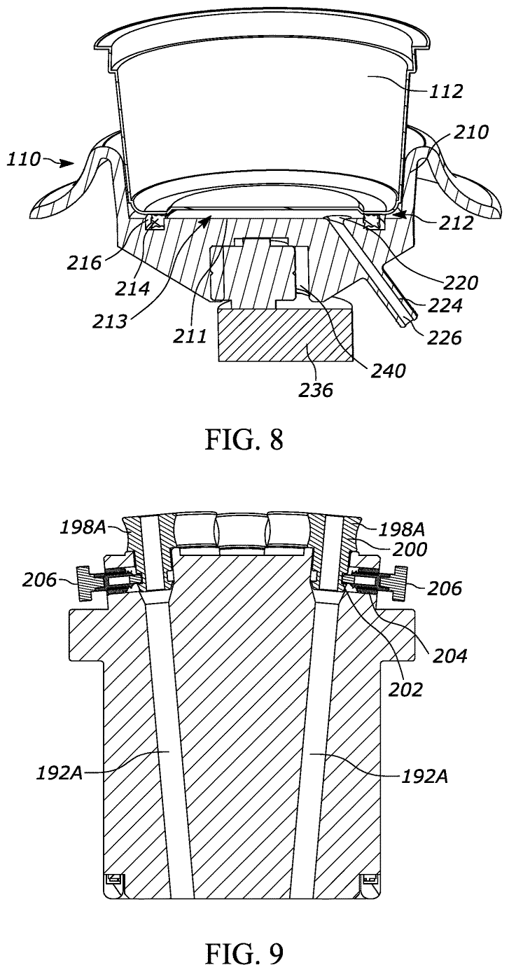

The cup holder 110 may include a seal 214 disposed within the recess 212 and on the bottom wall 211 of the cup holder 110 to form a vacuum chamber 213 (see FIG. 8) with the cup 112, the seal 214 and the bottom wall 211 when the cup 112 is inserted in the cup holder 110. For example, the cup 112 may be inserted into the recess 212 until the bottom surface of the cup engages the seal 214 to form a fluid tight seal therebetween. Forming a vacuum chamber 213 with the cup 112 increases the force of the suction on the cup 112 and therefore increases the force retaining the cup 112 in the cup holder 110. The seal 214 may be positioned to engage a bottom surface of the cup 112 when the cup 112 is inserted therein. The seal 214 may be an annular seal such as an O-ring or an X-ring. The bottom wall 211 of the cup holder 110 may include an annular groove 216 that receives at least a portion the seal 214. The seal 214 may be secured to the bottom wall 211 by a friction fit with the annular groove 216 and/or an adhesive.

The cup holder 110 may include a tube portion 224 defining a passageway 226 extending from the opening 220 in the bottom wall 211 of the cup holder 110. An end of a hose or tube 228 may be connected to the tube portion 224 of the cup holder 110. The tube 228 may extend from the cup holder 110 to a vacuum pump 230 of the vacuum system 222. The vacuum system 222 may be mounted to the door 106 along with the cup holder 110 to keep the vacuum system 222 coupled to the cup holder 110 when the door 106 is opened. The vacuum pump 230 may be operated to draw air out of the cup holder 110 through the opening 220 via the tube 228. When the vacuum chamber 213 is formed by the cup 112, seal 214 and bottom wall 211 of the cup holder 110, operation of the vacuum pump 230 creates suction that holds the cup 112 in the cup holder. In some forms, the vacuum system 222 further includes a solenoid operable to open and close a valve to maintain the suction in the vacuum chamber 213 without operating the vacuum pump 230 continuously while condiment is dispensed. For instance, the vacuum pump 230 may be operated until the pressure reaches or is below a predetermined threshold to form the vacuum chamber 213. The solenoid may be used to close the valve to hold the pressure in the vacuum chamber 213 and then the vacuum pump 230 may be shut off. To release a cup from the cup holder 110, the solenoid is used to open the valve permitting air to flow into the cup holder 110 and removing suction from the cup 112. The vacuum system 222 may include a filter system to inhibit condiment from entering the vacuum pump 230, for example, condiment spilled within the cup holder 110.

The condiment dispenser 100 may be able to detect the presence of the cup 112 based on the pressure in the vacuum chamber 213 and/or tube 228. For instance, when the vacuum pump 230 is operated, the pressure in the cup holder 110 may be significantly lower when the cup 112 is inserted than when a cup 112 is not inserted. The condiment dispenser 100 may operate the vacuum pump 230 and determine that a cup 112 has been placed in the cup holder 110 based on the pressure and/or when the pressure drops significantly (e.g., as the cup 112 is inserted). The condiment dispenser 100 may additionally or alternatively include a sensor 231 to detect whether a cup 112 is in the cup holder 110. The sensor 231 may be a proximity sensor that detects when the cup 112 is positioned adjacent the sensor 231. For example, the sensor 231 may be positioned on the bottom wall 211 of the cup holder 110 to sense the presence of the bottom of the cup 112 when the cup 112 is inserted therein.

Securing the cup 112 within the cup holder 110 is advantageous to ensure that the cup 112 remains in the proper position while the condiment is dispensed from the dispensing head 114 and to ensure the condiment is dispensed into the cup and not spilled. Firmly securing the cup 112 within the cup holder 110 may also keep the cup 112 in the proper position when mixing the condiment within the cup 112.

In some embodiments, the condiment dispenser 100 is loaded with cups such that the user does not need to add a cup to the condiment dispenser 100 to be filled with condiment. The condiment dispenser 100 may separate a cup from a stack of cups loaded into the dispenser. Upon receiving a request for a condiment mixture from the user (e.g., via the user interface 282), the condiment dispenser 100 may fill the cup with the condiments, mix the condiments, and output the cup with the mixed condiment to the user.

With respect to FIGS. 10C-10D, the condiment dispenser 100 may include an agitator system 232 to swirl, spin, vibrate, shake, or otherwise mix the condiment dispensed into the cup 112. The agitator system 232 may be, for example, a vortex mixer, oscillating mixer, and/or shaking mixer. As discussed above, two or more types of condiment and/or accent flavors may be dispensed from the dispensing head 114 into the cup 112. The agitator system 232 may be operated to mix the two or more condiments and/or accent flavors together, for example, to form a generally homogenous mixture.

The agitator system 232 may be mounted to the door 106 of the condiment dispenser 100. The agitator system 232 may be configured to generate motion and may be connected to the cup holder 110 to transfer the motion to the condiment in the cup holder 110. The agitator system 232 may be or include a vortex mixer that includes a motor 234 that drives an agitator head 236. The motor 234 is operable to rotate a shaft. The agitator head 236 is connected to the shaft of the motor 234 and slightly off-center from the shaft such that rotation of the shaft causes the agitator head 236 to oscillate in a circular motion about the shaft. The agitator head 236 may be positioned to engage the cup holder 110 such that operation of the motor 234 causes the agitator head 236 to rapidly oscillate the cup holder 110 in a circular motion as the agitator head 236 oscillates about the motor shaft. The agitator head 236 may include a shaft portion 238 sized to extend into an opening 240 in the bottom of the cup holder 110. The agitator head 236 may include an elastomeric body 242, such as a sleeve and/or ring(s), mounted on the shaft portion 238 of the agitator head 236. The elastomeric body 242 may be positioned to engage the cup holder 110 to dampen the impact between the agitator head shaft portion 238 and cup holder 110 during operation. The elastomeric sleeve and/or ring may be formed of a material such as a rubber and/or a silicone. The shaft portion 238 of the agitator head 236 thus transfers the oscillating motion to the cup holder 110 to oscillate, vibrate, and/or shake the cup holder 110.

Oscillation of the cup holder 110 by the agitator system 232 causes the cup 112 within the cup holder 110 to oscillate which transfers the motion to the condiments within the cup 112. The oscillating motion of the cup 112 may swirl the condiment within the cup (e.g., form a vortex) and cause the condiment to be mixed together. The condiment may be mixed until the condiment in the cup 112 is a homogenous mixture, for example, with the accent flavor evenly distributed throughout the base condiment. The agitator system 232 may be operated for a period of time until the condiment is thoroughly mixed, for example, a time period in the range of about 1 to 30 seconds or about 15 to 20 seconds. In other embodiments, the condiment may additionally or alternatively be mixed by, as examples, magnetic stirring, overhead stirring, and/or ultrasonic blending.

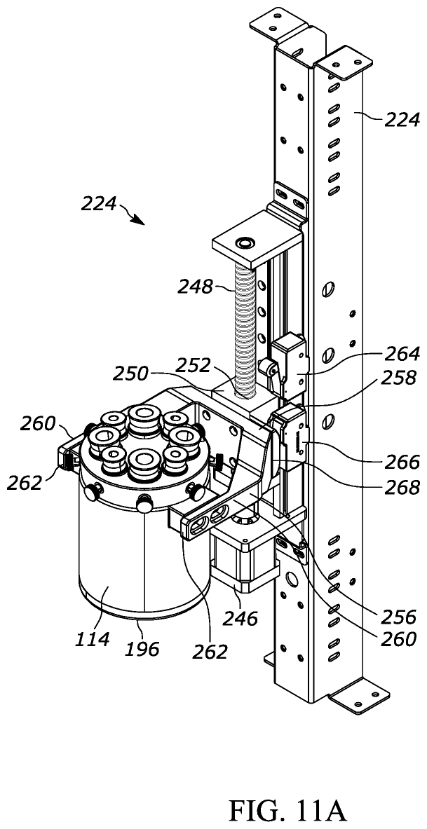

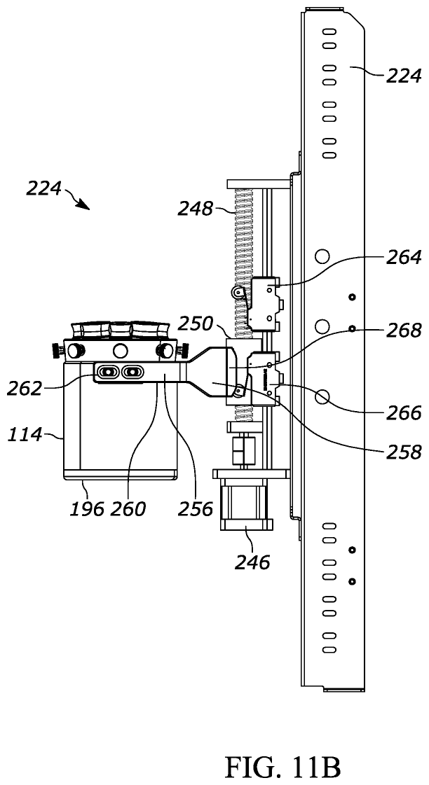

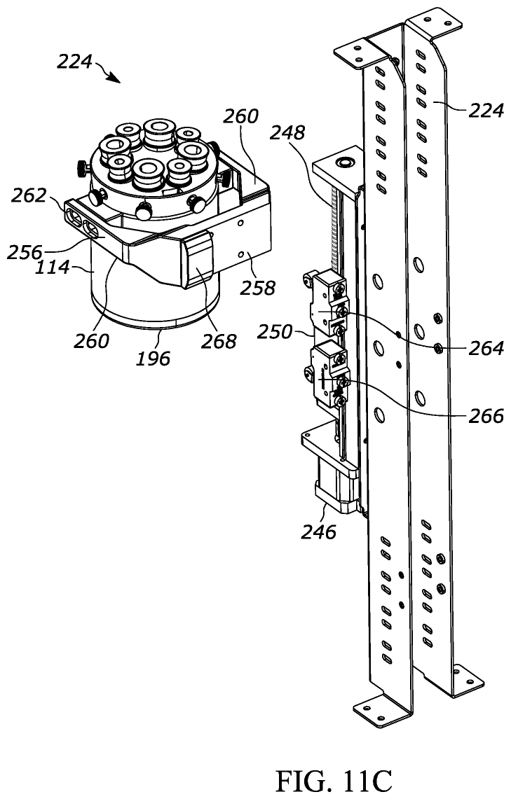

With respect to FIGS. 11A-11C, the condiment dispenser 100 may include a linear actuator such as a lift system 244 operable to raise or lower the dispensing head 114. Specifically, the lift system 244 may operated to lower the position of the outlet end 196 of the dispensing head 114 to be adjacent to or just above a cup 112 in the cup holder 110. Lowering the dispensing head 114 to be closer to the cup 112 aids to ensure the condiment is dispensed into the cup and reduces or eliminates drip or splatter falling outside of the cup. The outlet end 196 of the dispensing head 114 may be lowered into the pocket 111 of the front door 106 through an opening in the top portion of the pocket 111. The dispensing head 114 may be lowered when the dispensing head 114 is to dispense condiment, for example, after detecting that a cup 112 has been positioned in the cup holder 110 and/or after receiving the selection of one or more condiments from the user interface 282. The dispensing head 114 may be raised to lift the dispensing head 114 out of the pocket 111, for example, after dispensing the selected condiment(s) into the cup 112. Raising the dispensing head 114 from the cup 112 may provide clearance for the user to remove their cup 112 from the cup holder 110, for example, without touching the dispensing head 114. The dispensing head 114 may also be raised out of the pocket 111 of the front door 106 to permit the front door 106 of the condiment dispenser is to be opened, for example, to replace a condiment pouch 120 and/or service the condiment dispenser.

The lift system 244 includes a motor 246 operable to rotate a threaded shaft 248. The motor 246 and threaded shaft 248 may be mounted to the longitudinal support 124. The lift system 244 includes a trolley 250 mounted to the threaded shaft 248. The trolley 250 may include a threaded opening 252 to which the threaded shaft 248 is threaded. Operation of the motor 246 causes the motor 246 to rotate the threaded shaft 248 and cause the trolley 250 to move axially along the threaded shaft 248. The trolley 250 moves upward or downward along the shaft 248 based on the direction of rotation of the shaft 248 by the motor 246.

The dispensing head 114 is connected to the trolley 250 such that movement of the trolley 250 by the motor 246 moves the dispensing head 114. The dispensing head 114 may be mounted to the trolley 250 by a yoke or support bracket 256. The support bracket 256 includes a base portion 258 and two arms 260 extending from the base portion 258 to form a substantially U-shaped bracket. The base portion 258 may be mounted to the trolley 250, for example, by one or more fasteners and/or an adhesive. The arms 260 extend from the base portion 258 and form a space therebetween for receiving the dispensing head 114. Ends 262 of the arms may be mounted to opposing sides of the dispensing head 114 to support the dispensing head 114 from the trolley 250 and lift system 244.

The motor 246 of the lift system 244 may thus be operated to move the dispensing head 114 between a raised position and a lowered position as discussed above. The lift system 244 may further include an upper limit switch 264 and a lower limit switch 266 to detect when the trolley 250 has reached the raised and lowered positions, respectively. The upper and lower limit switches 264, 266 may be mounted along the longitudinal support 124. A limit switch dog 268 may be mounted to the trolley 250 and/or support bracket 256 that travels with the trolley 250 as the motor 246 moves the trolley 250 along the shaft 248. The limit switch dog 268 is positioned to contact the upper limit switch 264 or lower limit switch 266 when the trolley 250 reaches the raised or lowered position. A processor 276 of the condiment dispenser 100 may receive a signal from the upper and lower limit switches 264, 266 when the limit switch dog 268 contacts or has reached the limit switch. Upon receiving the signal from the upper or lower limit switch 264, 266, the processor 276 may determine that the dispensing head 114 has reached the raised position or lower position, respectively, and cease operating the motor 246.

In some forms, the processor 276 may move the dispensing head 114 between three positions: a loading position; a standby position; and a dispensing position. The dispensing head 114 may be in the loading position when the processor 276 detects that the front door 106 is open and/or that the condiment pouches 120 are being loaded or replaced. In the loading position, the dispensing head 114 may be at its highest point with the limit switch dog 268 at the upper limit switch 264. In the loading position, the dispensing head 114 is positioned to permit the pouch support trays 140 to be inserted and withdrawn without interference from the dispensing head 114. When the door 106 is closed and the condiment dispenser 100 is not dispensing condiment, the dispensing head 114 may be in the standby position. The standby position may be slightly below the loading position but above the dispensing position to provide clearance for a user to position a cup 112 in the cup holder 110 or to remove a cup 112 from the cup holder 110. When the condiment dispenser 100 is ready to dispense the condiments, the dispenser head 114 may be moved to the dispensing position where the limit switch dog 268 contacts the lower limit switch 266. Upon dispensing the condiment, the dispensing head 114 may be moved upward back to the standby position to permit the user to withdraw the cup and to avoid a user contacting the dispensing head 114.

In other embodiments, the cup holder 110 may similarly be mounted to a lift system that raises and lowers the cup holder 110 relative to the dispensing head 114.

In some embodiments, the condiment dispenser 100 includes a movable guard that slides over the pocket 111 to inhibit the user from reaching into the pocket 111, for example, to remove the cup 112 during a dispensing cycle. When the user positions the cup 112 in the cup holder 110 and requests a condiment mixture, the guard may be moved to cover the pocket 111 or a portion thereof. Once the condiment mixture has been dispensed and mixed, the guard may be moved to permit the user to reach into the pocket 111 to remove the cup 112 from the cup holder 110.

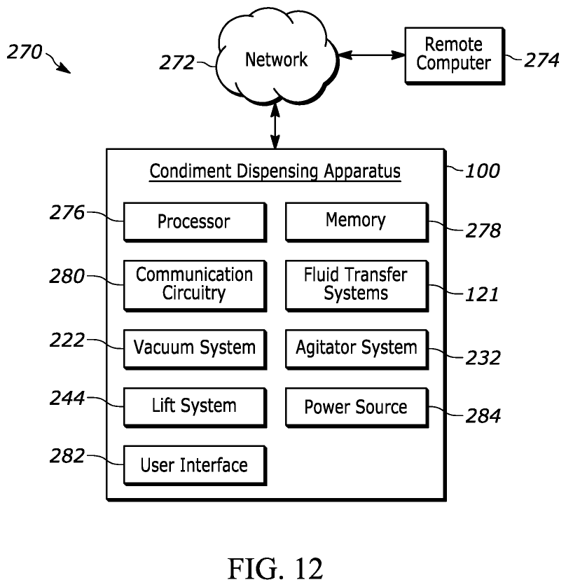

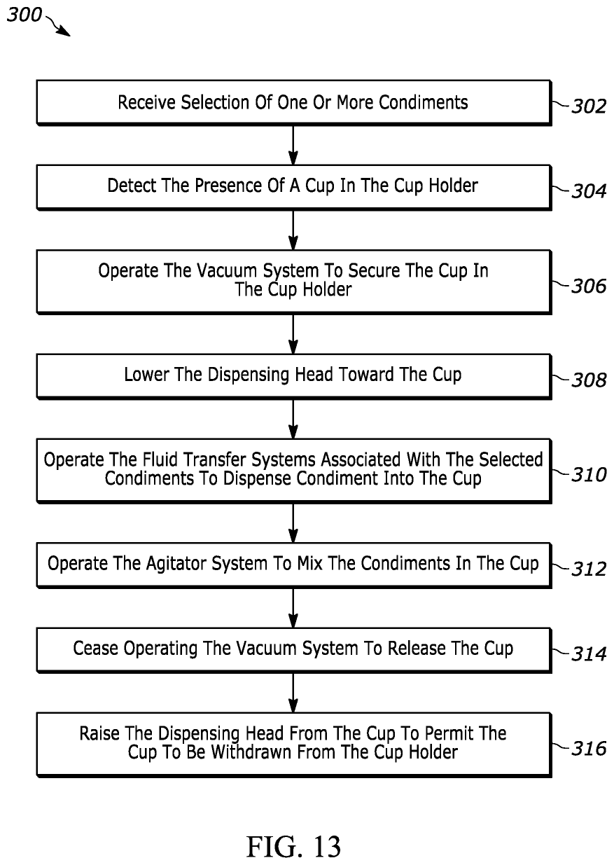

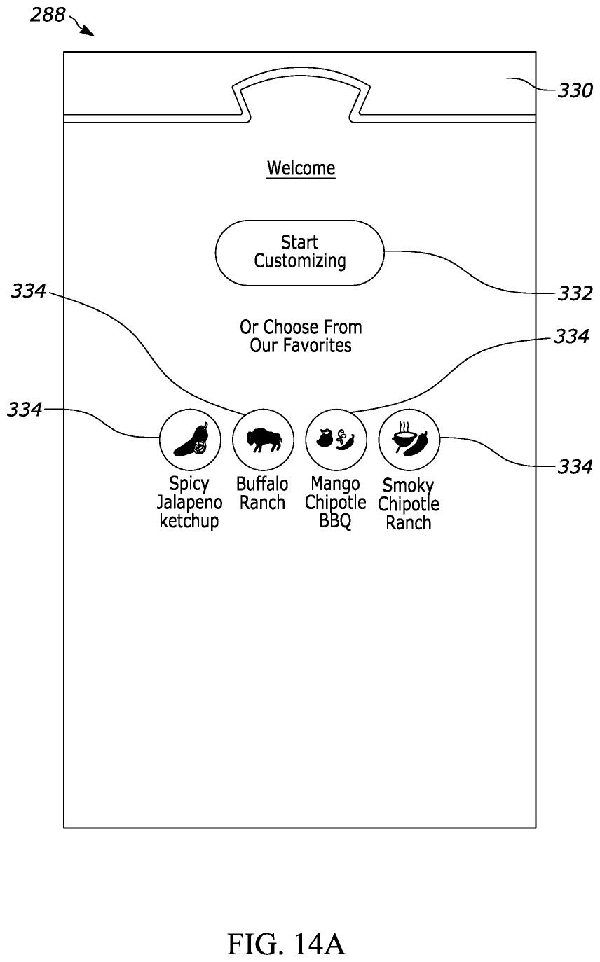

With respect to FIG. 12, a condiment dispensing system 270 is shown. The condiment dispensing system 270 includes the condiment dispenser 100, a network 272, and a remote computer 274. The condiment dispenser 100 includes a processor 276 and memory 278. The memory 278 may include programs and instructions for carrying out various operations and providing functionality to the condiment dispenser 100. For example, the memory 278 may include instructions for operating the pumps 122, the lift system 244, the vacuum system 222, and the agitator system 232. For instance, the memory 278 may store data regarding how long to operate the pump 122 to dispense a certain amount of condiment from the dispensing head 114 into the cup 112. The memory 278 may also store data regarding how much condiment has been dispensed from each condiment pouch 120 (e.g., since it was loaded into the condiment dispenser 100) and/or how many doses of the condiment have been dispensed. The processor 276 may determine how much condiment is left in each condiment pouch 120 by tracking the number of doses that have been dispensed since a full condiment pouch 120 was installed. The processor 276 may individually control each of the motors 170 associated with the pumps 122 to cause the pumps 122 to pump condiment into the cup 112. The processor 276 may also control the motor 246 of the lift system 244 to raise or lower the dispensing head 114, control the motor 234 of the agitator system 232 mix the condiment in the cup 112, operate the vacuum pump 230 of the vacuum system 222 to retain the cup 112 in the cup holder 110. The processor 276 is configured to communicate with the memory 278 to access the programs and instructions to provide functionality to the condiment dispenser 100 as described in further detail below with respect to FIG. 13.

The condiment dispenser 100 further may include communication circuitry 280. The processor 276 may use the communication circuitry 280 to communicate with remote devices. For example, the communication circuitry 280 may be configured to communicate via wired and wireless communication protocols including, as examples, cellular, Wi-Fi, Bluetooth, NFC, Zigbee, ethernet, and the like. The processor 276 may communicate signals via the communication circuitry 280 to remote devices and receive signals from remote devices via the communication circuitry 280. The condiment dispenser 100 may be configured to communicate with the remote computer 274 (e.g., a server computer) via the network 272 using the communication circuitry 280. The network 272 may include a cellular network, Wi-Fi network, and/or the internet as examples. The condiment dispenser 100 may communicate data with the remote computer 274 such as how much condiment is left in the condiment pouches 120, the types and amounts of condiment mixtures that have been dispensed (e.g., to track usage of each condiments for consumption rates, and/or when the condiment dispenser 100 should be cleaned (e.g., based on the length of time since a condiment pouch 120 and/or a tube 166 has been replaced). For instance, the condiment dispenser 100 may record and communicate the type and amount of each condiment that has been dispensed so that the usage of each condiment can be tracked. For example, the usage of each condiment may be used to track which condiments/mixtures are popular and/or consumption rates for each condiment to (e.g., so that additional condiment can be ordered and received before running out). The condiment dispenser 100 and/or remote computer 274 may communicate with a user via the communication circuitry 280, for example a user device (e.g., a smartphone, tablet, personal computer, cash register, etc.) to alert a user or staff of a restaurant when one or more of the condiment pouches 120 are low or running low and/or to clean the condiment dispenser 100.

The condiment dispenser 100 may also alert the user or staff to errors and/or when the condiment dispenser 100 should be serviced. The condiment dispenser 100 and/or remote computer 274 may be associated with a smartphone application and information pertaining to the condiment dispenser 100 may be presented to the user and/or viewable by a user in the smartphone application. A user may also be able to use the smartphone application (or other such program) to record the type of condiment the user has installed in which dock 137 of the condiment dispenser 100 and the time/date when the condiment pouch 120 was installed. A user may also use the smartphone application (or similar program) to determine how much of each condiment is left in the condiment dispenser 100 and/or when the condiment cartridge was installed (e.g., by viewing this data in the smartphone application). The condiment dispenser 100 may also include a user interface 282, for example, a touchscreen display, that the user may operate to access and enter such information from memory 278 and/or the remote computer 274.

The condiment dispenser 100 may be powered by a power source 284. The power source 284 may include an electrical cord with a plug for attaching to a wall outlet to receive mains power. Alternatively or additionally, the power source 284 may include a battery. The battery may be replaceable and/or rechargeable. Powering the condiment dispenser 100 with a battery increases the locations within a restaurant where the condiment dispenser 100 may be placed. For example, the condiment dispenser 100 need not be placed close to an electrical outlet.

With respect to FIG. 13, a method 300 of operation of the condiment dispenser 100 is provided. While the steps of the method are described in one order, those having skill in the art will readily appreciate that the order of the steps may be rearranged. Moreover, those having skill in the art will readily appreciate that not all steps are necessary and that some steps may be optional. The method includes the condiment dispenser 100 receiving 302 a selection from a user of one or more condiments to be dispensed. The user may make a selection of one or more condiments to be dispensed using the user interface 282 as discussed below. For example, the user may select a first condiment and a second condiment to be mixed with the first condiment. In one approach, the user may select a base condiment and an accent condiment or flavoring to be added to and mixed with the base condiment. The processor 276 may receive the condiment selection and store the selection in memory 278. The processor 276 may also determine which fluid transfer systems 121 of the condiment dispenser 100 are associated with the user's condiment selection.

The condiment dispenser 100 may detect 304 whether a cup 112 has been positioned in the cup holder 110. The condiment dispenser 100 may use the vacuum system 222 and/or the sensor 231 (e.g., a proximity sensor) to detect the presence of the cup 112 in the cup holder 110. The processor 276 may be in communication with the sensor 231 and determine whether the cup 112 is properly positioned within the cup holder 110 based on the signal received from the sensor 231. The processor 276 may present a message via the user interface 282 to prompt the user to insert the cup 112 into the cup holder 110 and/or to adjust the position of the cup 112 (e.g., press the cup 112 in further) until the cup 112 is properly positioned.

The condiment dispenser 100 operates 306 the vacuum system 222 to secure the cup 112 in the cup holder 306. The processor 276 may control the vacuum system 222 and turn on the vacuum pump 230 when a condiment selection is received. The vacuum pump 230 creates suction within the cup holder 110 to draw the cup 112 into the cup holder 110 and to retain the cup 112 therein. The vacuum system 222 may be operated to retain the cup 112 in the cup holder 110 during the mixing process discussed below to inhibit the cup 112 from exiting the cup holder 110. As mentioned above, the vacuum system 222 may be used to determine whether the cup 112 is positioned in the cup holder 110. The processor 276 may detect 304 whether the cup 112 is positioned in the cup holder 110 based on the suction of the vacuum system 222. For example, when the vacuum chamber 213 is formed between the cup holder 110 and the cup 112, the pressure may be significantly lower than when the cup 112 is not in or properly positioned in the cup holder 110. Upon detecting a low pressure associated with the presence of a cup, the processor 276 may determine that the cup 112 is secured within the cup holder 110.

The processor 276 may control the lift system 244 to lower 308 the dispensing head 114 toward the cup 112. In particular, the processor 276 may operate the motor 246 of the lift system 244 to lower the trolley 250 and thus the dispensing head 114 until the dispensing head 114 reaches the lowered, dispensing position where the dispensing head 114 is just above the cup 112 (e.g., to ensure the condiment dispensed enters the cup 112). The processor 276 may determine the dispensing head 114 has reached the lowered position upon receiving a signal from the lower limit switch 266 indicating the limit switch dog 268 has contacted the lower limit switch 266.

The processor 276 operates 310 the fluid transfer systems 121 that are associated with the selected condiments to dispense the selected condiment into the cup. Specifically, the processor 276 may control the motors 170 of these fluid transfer systems 121 to move condiment from the condiment pouches 120 along the tubes 166 toward the dispensing head 114. The processor 276 may operate the motors 170 for a certain period of time to dispense a certain amount or precise dosage of the condiment from the dispensing head 114 into the cup 112. For example, where the user selected the condiments ketchup and sriracha sauce, the processor 276 may operate the fluid transfer system 121 associated with the ketchup condiment pouch 120 and the fluid transfer system 121 associated with the sriracha sauce condiment pouch 120. The association between the condiment type and each fluid transfer system 121 may be stored in memory 278. The processor 276 may retrieve information from the memory 278 to determine which fluid transfer systems 121 to operate responsive to a user's condiment selection. In some forms, the processor 276 operates each fluid transfer system 121 simultaneously so that the condiments are dispensed into the cup 112 substantially simultaneously. In some forms, the processor 276 operates one fluid transfer system 121 to dispense a first condiment and then operates a second fluid transfer system 121 to dispense the second condiment.

Where multiple condiments have been selected, the processor 276 may operate 312 the agitator system 232 to mix the condiments in the cup 112. The processor 276 may cause the motor 234 to operate for a period of time to mix the condiments together, for example, until the condiment mixture is substantially homogenous. The processor 276 may retrieve information from memory 278 regarding how long to operate the agitator system 232 to mix the condiment together. The length of time that agitator system 232 is operated may depend on the types of condiments dispensed. For example, more viscous condiments may be agitated for a longer period of time to ensure proper mixing. In some approaches, the processor 276 may begin operation of the agitator system 232 before the condiments are dispensed into the cup 112. The agitator system 232 may be operated while the condiments are being dispensed and may even be operated for a period of time after the condiments are dispensed until the condiments have been fully mixed. In some approaches, the processor 276 begins operation of the agitator system 232 after the condiments have been dispensed into the cup 112. In yet other approaches, the processor 276 begins operation of the agitator system 232 at the same time as the processor 276 begins operating the fluid transfer system 121 to dispense condiment into the cup 112.

When the mixing process has been completed, the processor 276 may cause the vacuum system 222 to cease 314 operating to release the cup 112. With the vacuum system 222 is turned off, the vacuum pump 230 is no longer creating suction in the cup holder 110. The cup 112 may thus be withdrawn from the cup holder 110 without having to overcome the force on the cup 112 caused by the vacuum system 222 to retain the cup 112. The processor 276 may control the lift system 244 to raise 316 the dispensing head 114 from the cup 112. In particular, the processor 276 may operate the motor 246 of the lift system 244 to raise the trolley 250 and thus the dispensing head 114 until the dispensing head 114 reaches the raised, standby position, for example, where the dispensing head 114 is withdrawn from the pocket 111. In some forms, the processor 276 may determine the dispensing head 114 has reached the raised position upon receiving a signal from the upper limit switch 264 indicating the limit switch dog 268 has contacted the upper limit switch 264. Once the dispensing head 114 has been raised, the cup 112 containing the condiment mixture may be withdrawn from the cup holder 110 by the user.

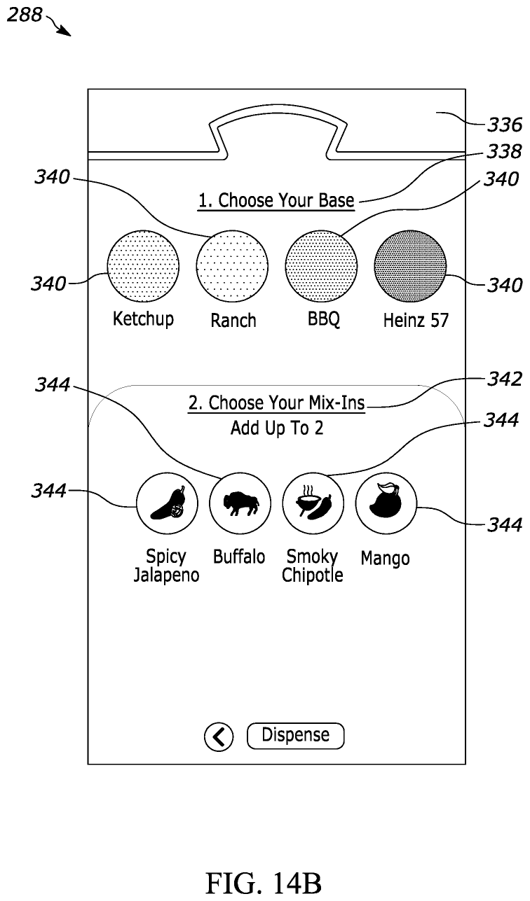

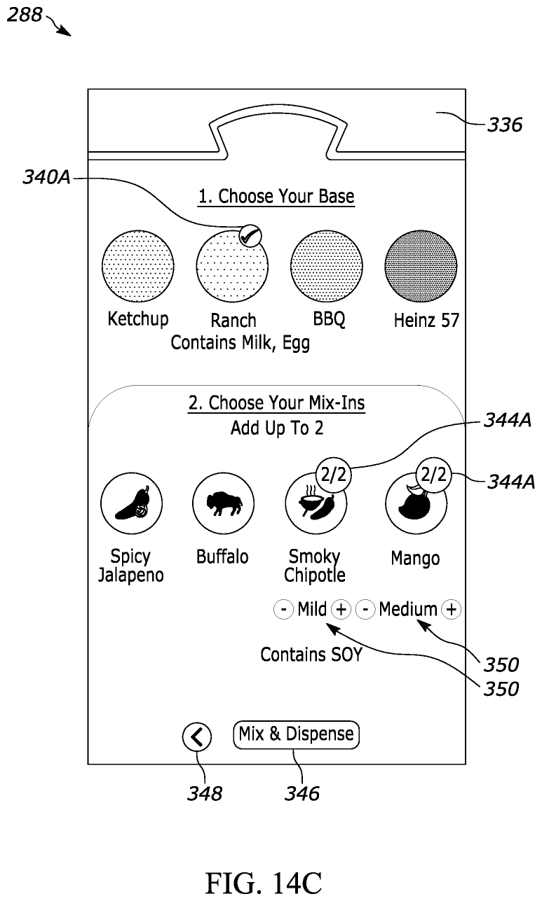

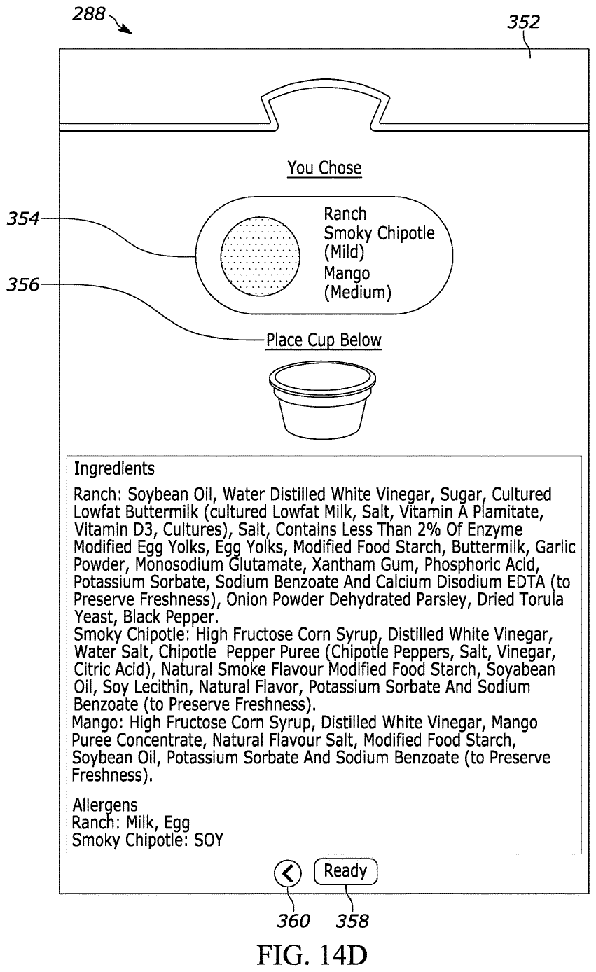

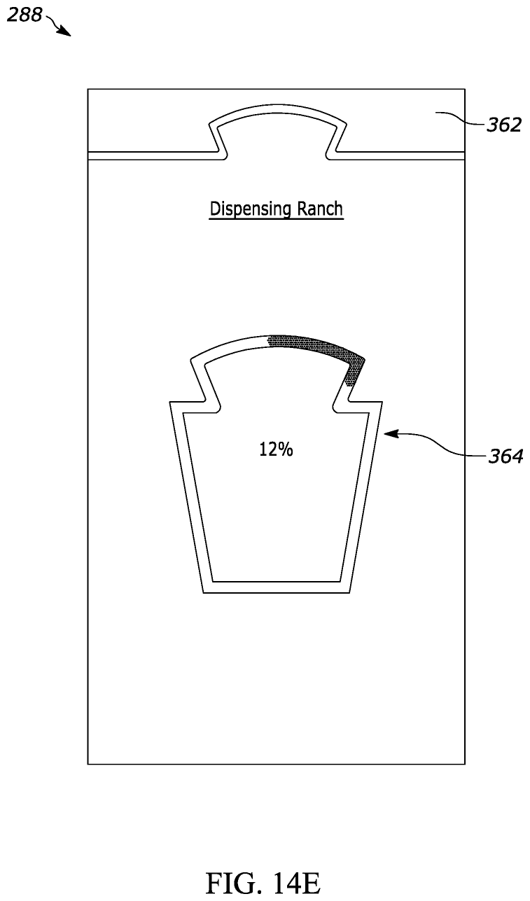

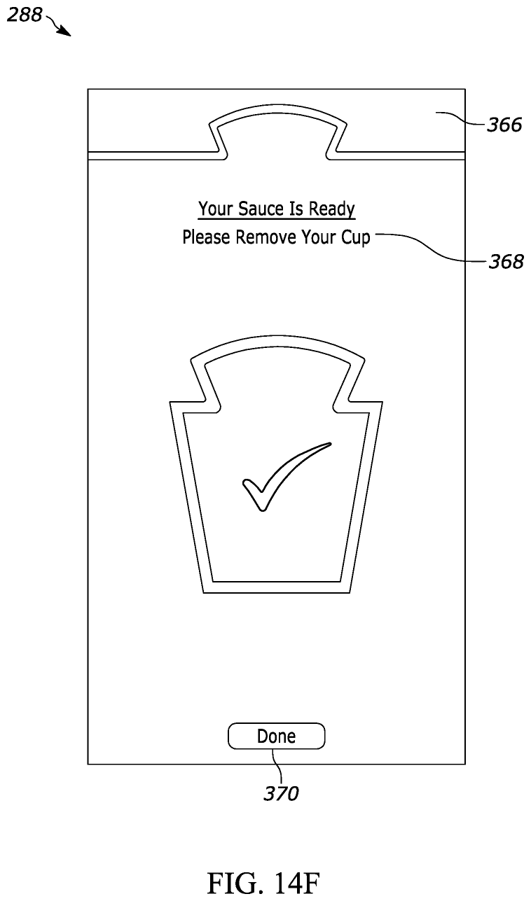

With respect to FIGS. 14A-14F, example graphical user interface (GUIs) screens are shown that may be presented to the user via a display screen 288 (e.g., of a touchscreen display) of the user interface 282 to order or select condiments. With respect to FIG. 14A, the display screen 288 of the condiment dispenser 100 provides the user with a GUI 330 presenting the user with a button 332 (e.g., a virtual button) to begin creating or customizing a condiment mixture. The GUI 330 further presents the user with buttons 334 to select a condiment mixture from a list of favorites or presets, for example, spicy jalapeno ketchup, buffalo ranch, mango chipotle barbeque, and smoky chipotle ranch. If the user selects one of these buttons 334, the condiment dispenser 100 may display the GUI 352 shown in FIG. 14D, discussed below.

With respect to FIG. 14B, if the user selects the button 332 to customize a condiment, the condiment dispenser may display the GUI 336 that includes a prompt 338 to the user to select a base condiment. The GUI 336 may include a plurality of buttons 340 corresponding to each base condiment that user may select to choose the base condiment. In the example shown, the user may select a base condiment from the options of ketchup, ranch, barbeque sauce, and Heinz® 57. While the example GUI 336 includes four base condiments, in other embodiments, more or fewer base condiments could be presented if more or fewer types of condiments were loaded into the condiment dispenser 100. The GUI 336 may further include a prompt 342 to the user to select a mix-in condiment, for example, an accent flavoring or secondary condiment. The GUI 336 may include a plurality of buttons 344 corresponding to each mix-in condiment. The condiment dispenser 100 may be configured to permit a user to select one, two, or more mix-in condiments to add to the selected base condiment. In the example shown, the user may select a mix-in from the options of spicy jalapeno, buffalo, smoky chipotle, and mango. While the example GUI 336 includes four different mix-in options, in other embodiments, more or fewer mix-in options could be presented if more or fewer types of mix-ins were loaded into the condiment dispenser 100.

Once the user has selected the base condiment and any desired mix-ins, the condiment dispenser 100 may update the GUI 336 to include an indication 340A of which base condiment the user has selected and an indication 344A of which and mix-ins the user selected. The GUI 336 may present buttons 350 (e.g., plug/minus buttons) associated with the selected mix-ins that the user may use to adjust the ratio of the mix-in to the base, for example, to adjust the strength of the mix-in flavor. Once the desired base condiment, mix-ins, and mix-in strength has been selected, the user may select the button 346 labeled “mix & dispense” to request the condiment dispenser 100 dispense the selected condiment mixture. If the user decides to return to the initial screen, the user may select the back button 348.

With respect to FIG. 14D, once the user has selected a condiment mixture to be dispensed, the condiment dispenser 100 may present a GUI 352 that displays the condiment selection 354 (e.g., the base condiment and mix-ins the user has selected). The GUI 352 may further present a prompt 356 to the user to place their cup 112 in the cup holder 110. The GUI 352 may further include a button 358 labeled “Ready” that the user may select to proceed to request the selected condiment mixture. If the user decides to adjust the selected condiment mixture, the user may select the back button 360.

With respect to FIG. 14E, once the user has selected the button 358, the condiment dispenser 100 begins to dispense the selected base condiment and mix-ins from the dispensing head 114 into the cup 112 and to mix the base condiment and mix-ins together in the cup 112. The condiment dispenser 100 may display a GUI 362 that indicates the progress of the condiment dispenser in preparing the mixture. For example, the GUI 362 may include an indication 364 of the percentage to completion (e.g., 12%).

With respect to FIG. 14F, once the condiment dispenser 100 has completed dispensing and mixing the condiment mixture in the cup 112, the condiment dispenser 100 may display a GUI 366 that indicates the condiment mixture is ready and a prompt 368 to the user to remove the cup 112 from the cup holder 110. The GUI 366 may further include a button 370 labeled “Done” that the user may select to end the ordering process.

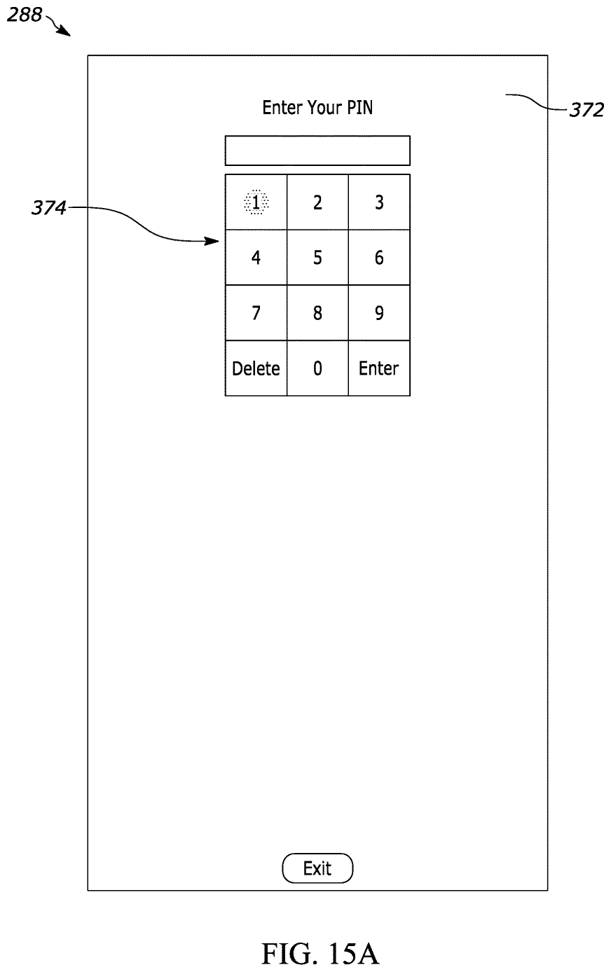

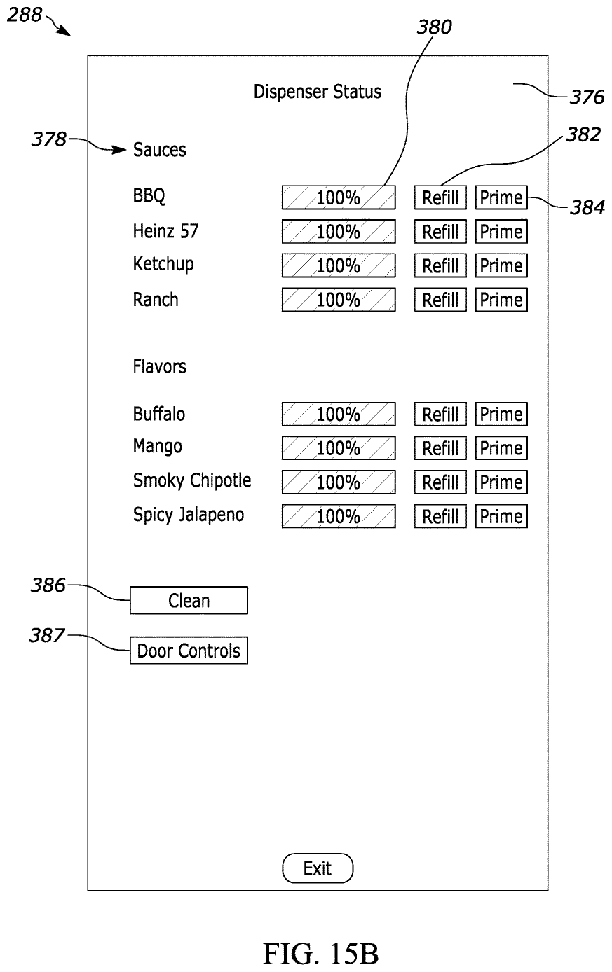

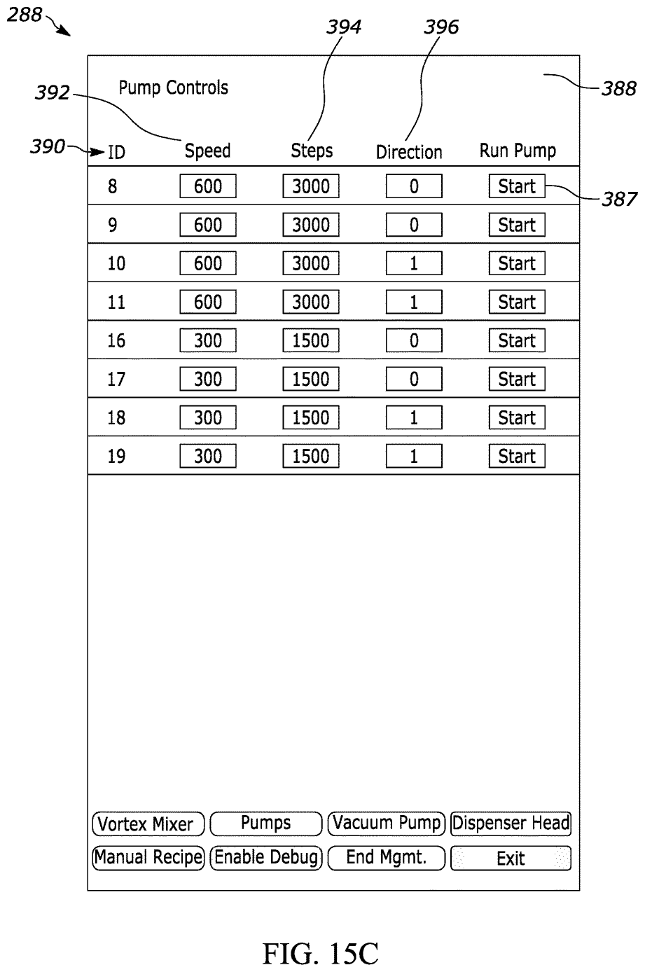

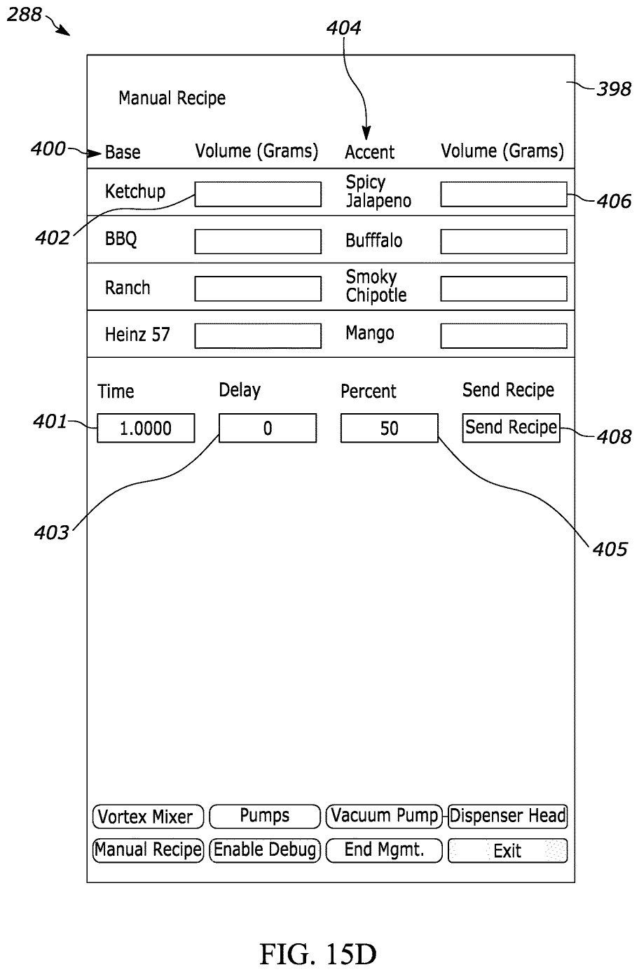

With respect to FIG. 15A-15D, example GUI screens are shown that may be presented to the user via a display screen 288 of the user interface 282 to service or adjust operation of the condiment dispenser 100. With respect to FIG. 15A, the condiment dispenser 100 displays a GUI 372 with a number pad 374 permitting a user to enter a code, such as a personal identification number (PIN), to gain access to the settings of the condiment dispenser 100. Upon entering the correct code, the condiment dispenser 100 may permit the user to view and/or adjust the status and settings of the condiment dispenser 100.

With respect to FIG. 15B, the condiment dispenser 100 may present a GUI 376 that displays a list 378 of each base condiment and mix-in of the condiment dispenser 100, along with an indication 380 (e.g., a status bar) of how much condiment remains in the corresponding condiment pouch 120 loaded into the condiment dispenser 100. As discussed above, the condiment dispenser may monitor the volume of the condiment dispensed to determine how much condiment remains. When the user replaces a condiment pouch 120, the user may select a button 382 of the GUI 376 to indicate that the condiment pouch 120 has been replaced with a full condiment pouch 120. The GUI 376 may also include a button 384 that the user may press to prime the condiment, for example, to operate the associated fluid transfer system 121 to move condiment from the condiment pouch and into the tube 166 to the dispensing head 114 to a position where the condiment dispenser 100 is ready to dispense the condiment into a cup 112. For instance, when the condiment pouch 120 is replaced with a full condiment pouch, the tube 166 may also be replaced and initially be empty and not filled with the condiment. The pump 122 will have to be operated for a period of time to move the condiment along the tube 166 to fill the tube 166 to the point that operation of the pump 122 dispenses the condiment through the dispensing head 114. Priming the condiment may ensure that condiment is actually dispensed when a user requests the condiment. Additionally, the user doesn't have to wait for the condiment dispenser to prime the condiment before dispensing the requested condiment mixture.

The GUI 376 may include a button 386 to clean the condiment dispenser 100. The condiment dispenser 100 may be configured to perform a self-clean cycle upon receiving a selection of the button 386. The self-clean cycle may include flushing each of the tubes 166 of the condiment dispenser 100 and/or openings 192 of the dispenser head 114 with a water and/or sanitizer. In other forms, the condiment dispenser 100 may be cleaned by detaching the tubes 166 from the condiment pouches 120, pumps 122 and dispensing head 114. The tubes 166 may be washed, for example, in a dishwasher or replaced with a new, clean tube 166. The GUI 376 may also include button 387 for allowing the door to be opened and closed, permitting access to the trays, condiments, tubes, and the like.

With respect to FIG. 15C, the condiment dispenser 100 may present a GUI 388 for adjusting the settings of each fluid transfer system 121. The GUI 388 includes a list 390 of IDs associated with each fluid transfer system 121 (e.g., each motor 170/pump 122 combination) along with the associated settings including the speed 392, the steps 394, and direction 296. The speed setting 392 may be a speed of the motor 170 that drives the pump, for example, the rotations per minute (RPMs). The speed of the motor 170 may be adjusted based on the type of condiment being pumped by the motor 170, the size of the tube 166 the condiment is pumped through, and other characteristics affecting the flow rate of the condiment through the tube 166. For example, the motors 170 associated with the more viscous base condiments may be set to 600 RPMs whereas the motors 170 associated with the mix-ins may be set to 300 RPMs. It should be noted that in some forms, stepper motors can be used such that the steps can similarly be controlled. The direction setting 396 may be a direction of the motor 170, for example, whether the motor 170 spins a shaft in the clockwise direction or counterclockwise direction to pump the condiment toward the dispensing head 114. The motor 170 may, however, be operated in the reverse direction to draw condiment away from the dispensing head 114, for example, after dispensing condiment to inhibit the condiment from dripping out of the dispensing head 114. The GUI 388 may further include a button 387 for each pump 122 that may be selected to run the pump 122, for example, to test its performance on its current settings.

With respect to FIG. 15D, the condiment dispenser 100 may present a GUI 398 for manually creating and requesting condiment mixture recipes. The GUI 398 may include a list 400 of each of the base condiments along with a text box 402 into which a user may type the volume of base condiment (e.g., the number of grams) of the condiment to be dispensed and mixed. The GUI 398 may include a list 404 of each of the mix-in condiments, along with a text box 406 into which a user may type the volume of the mix-in (e.g., the number of grams) to be dispensed and mixed. The user may thus enter which base condiments and mix-ins to be dispensed and mixed together along with the volume and ratio of each component in the mixture. The GUI 398 may include a button 408 that the user may select to enter the request for a condiment mixture having the specified volume of components entered into the text boxes 402, 406. As shown in FIG. 15D, time entry 401 can also be set for establishing the amount of time the machine mixes after dispensing is complete. Similarly, delay entry 403 can be used to delay the start of mixing while percent entry 405 can be used to set the speed of the mixing process.

The condiment dispenser may also be configured to connect to an operator dashboard/GUI that is located remotely from the dispenser. In this form, the remote dashboard can be used to track inventory, view maintenance status, track condiment combinations and data, revise the base condiments, revise the enhancer flavors, establish favorite combination, and the like.

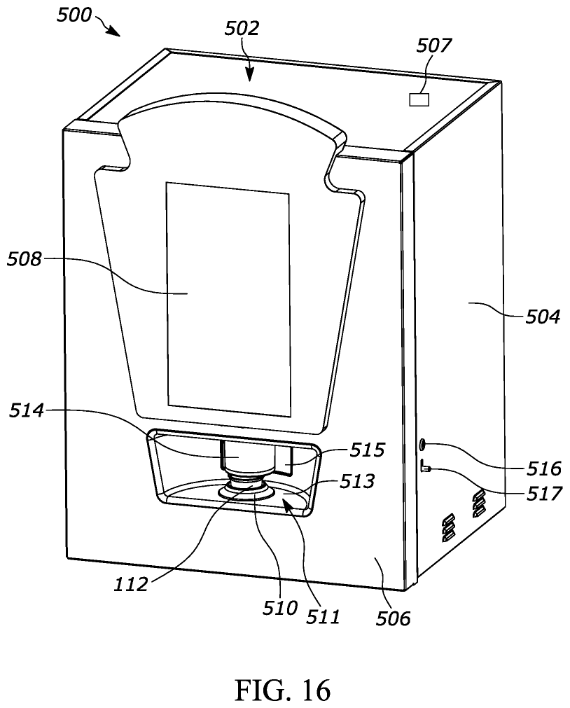

With reference to FIGS. 16-19D, a condiment dispenser 500 is provided according to another embodiment. The condiment dispenser 500 is similar in many respects to the condiment dispenser 100 such that the differences are highlighted. The condiment dispenser 500 has a housing 502 having a housing body 504 and front portion such as door 506. The door 506 includes a user interface 508, such as a touchscreen display that may be used to operate the condiment dispenser as discussed above.

The housing 502 includes recess or pocket 511 with a cup holder 510 to receive a receptacle such as cup 112 to be filled with condiment. In this embodiment, the pocket 511 includes a main body 513 and a panel 515. The main body 513 of the pocket 511 is coupled to the door 506 such that the main body 513 moves with the door 506 when pivoted about the hinged connection with the housing body 504. The panel 515 is coupled to the housing body 504 and does not move with the door 506. Having the panel 515 separate from the main body 513 of the pocket 511 permits the door 506 to be opened even if the dispensing head 514 is in the lowered position. When the door 506 is closed, the panel 515 inhibits access to the interior of the housing 502.

The condiment dispenser 500 may include a lock mechanism 516 to secure the door 506 to the housing body 504 in the closed position to inhibit unauthorized access to the interior of the condiment dispenser 500. For example, the lock mechanism 516 may include a lock cylinder such that a key is used to unlock the condiment dispenser 500. The condiment dispenser 500 also includes a latch 517 that may be moved (e.g., lifted) to open the door 506 when the condiment dispenser 500 is unlocked. Moving the latch 517 may unlatch the door 506 from the housing body 504 to permit the door 506 to be moved to the open position about the hinged connection to the housing body 504.

The condiment dispenser 500 may include an antenna 507 mounted to the housing 502 to enable the condiment dispenser 500 to send and receive wireless signals. The antenna 507 may, for example, be mounted on a top side of the housing body 504. The condiment dispenser 500 may use the antenna 507 to wirelessly communicate with remote devices such as a cash register, a server computer, and/or a user device such as a smartphone or computer tablet. The condiment dispenser 500 may use the antenna to communicate via direct and/or indirect communication protocols such as those discussed above. The condiment dispenser 500 may receive signals from a Global Navigation Satellite System (GNSS) via the antenna 507 and process the signals to determine the location of the condiment dispenser 500.

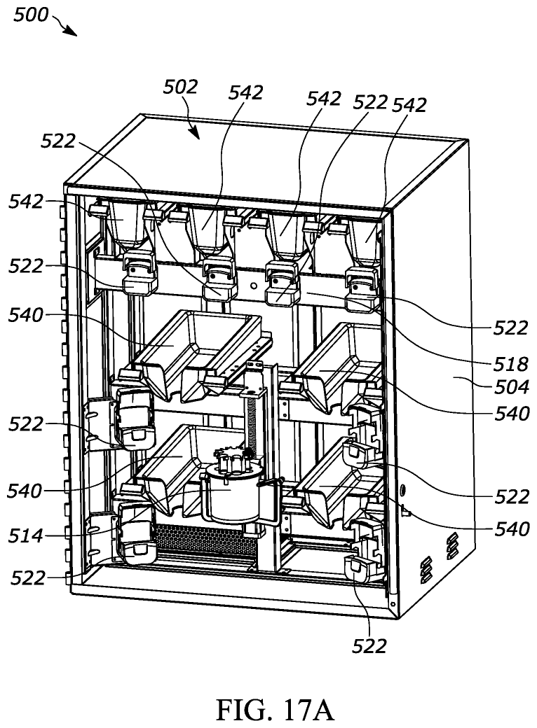

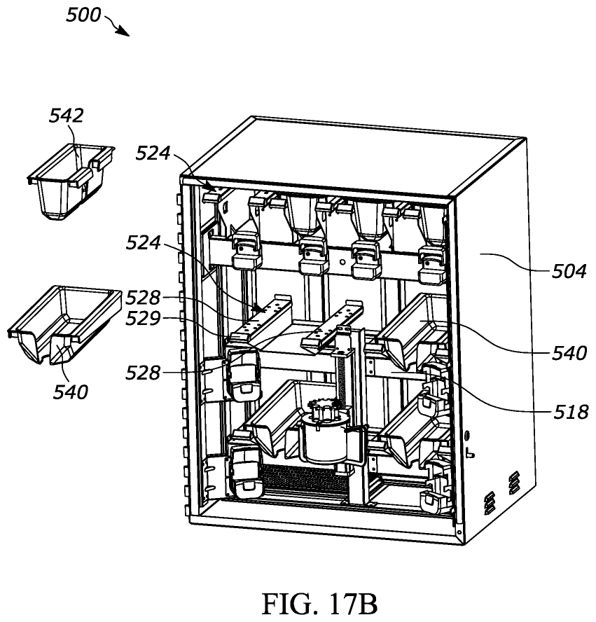

With respect to FIGS. 17A-17B, the condiment dispenser 500 includes an internal support frame 518 that supports condiment containers such as condiment pouches 120, pumps 522, and the dispensing head 514. The internal support frame 118 may include multiple levels of racks to support multiple condiment pouches 120. The condiment dispenser 500 includes weight sensors 524 on the support frame 518 that support large and small pouch support trays 540, 542. The weight sensors 524 may be used to weigh the condiment pouches 120 in the support trays 540, 542, for example, to determine how much of each condiment is left in the pouches 120 and to determine how much condiment has been dispensed during a dispensing cycle. The weight sensors 524 may be connected to a processor (e.g., like processor 276) of the condiment dispenser 500 that receives data from the weight sensors 524 to determine the weight or change in weight of each condiment pouch. The condiment dispenser 500 may notify a user when a condiment pouch needs to be replaced as discussed above. The condiment dispenser 500 may also monitor the change in weight of the condiment pouch to determine when to stop operating the pumps 522 during a dispensing cycle. For example, upon receiving a request for a condiment/condiment mixture, the condiment dispenser 500 may operate the pumps 522 of the requested condiments until the weight of the associated condiment pouch decreases by a specified amount, e.g., the amount specified in the recipe for the requested condiment mixture.

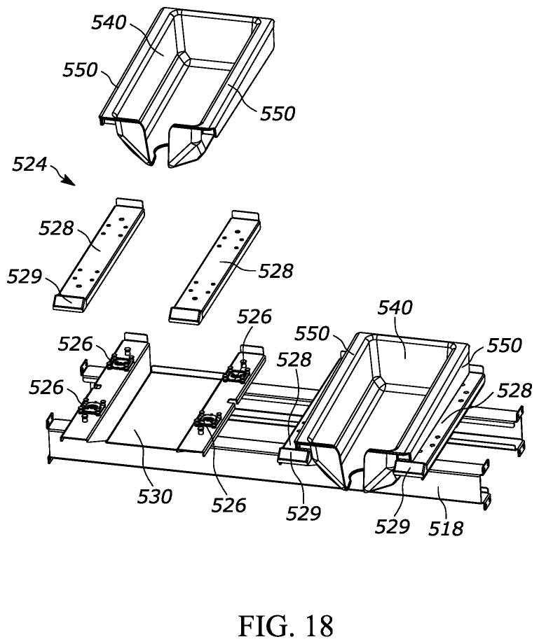

With reference also to FIG. 18, the weight sensors 524 may include one or more load cells 526 and one or more weight plates 528. While the following discussion relates primarily to the large support trays 540, the weight sensors 524 of the small support trays 542 may have similar structure and function similarly. The large support trays 540 may rest on a weight sensor 524 when loaded into the condiment dispenser 500 so that the weight of the support trays, and the condiment pouches therein, may be measured. In the form shown, each weight sensor 524 includes two weight plates 528 and four load cells 526. The load cells 526 are mounted to a tray bracket 530 that is coupled to the support frame 518 to receive the support trays 540. The weight plates 528 extend longitudinally into the condiment dispenser 500 across two of the load cells 526 to permit the support trays 540 to be inserted into and withdrawn from the condiment dispenser 500 along the weight plates 528 (e.g., slid rearward or forward along the weight plates 528).

The side flanges 550 of the support tray 540 each rest on a weight plate 528 when loaded into the condiment dispenser 500. The weight plates 528 serve to transfer the weight of the support tray 540 (and the condiment pouch therein) to the load cells 526. The processor of the condiment dispenser 500 may receive the sensor data output from each of the load cells 526 to determine the weight of the support tray 540 and condiment pouch. Use of multiple load cells, e.g., on both sides of the support tray 540 and toward the front and rear ends of the tray 540, enables accurate measurement of the weight of the support tray 540 and condiment pouch even if the weight of the condiment pouch is not evenly distributed in the support tray 540. The small support tray 542 similarly includes flanges that rest on the weight plates 528 to measure the weight of the support tray 542 and condiment pouch.

The weight plates 528 may include stop protrusions 529 at the front ends thereof to inhibit the support trays 540 from unintentionally sliding forward and out of the condiment dispenser 500. To remove the support trays 540, the front end may be lifted slightly and above the stop protrusion 529 before being pulled forward and out of the condiment dispenser 500.

In another form, the weight plates 528 for each support tray 540 are connected to one another to form a weight transfer body the support tray 540 may be positioned on. For example, a bridge member extends between the left and right weight plates 528. The left and right weight plates 528 may be formed unitarily (as a single piece) or as separate components rigidly secured together (e.g., a bridge member securing the left weight plate 528 to the right weight plate 528). The weight transfer body may rest on all four load cells 526 and distribute the weight of the support tray 540 across the load cells 526. Rigidly securing the left and right weight plates 528 together to form a weight transfer body may aid more evenly distributing the weight of the support tray 540 across the load cells 526.

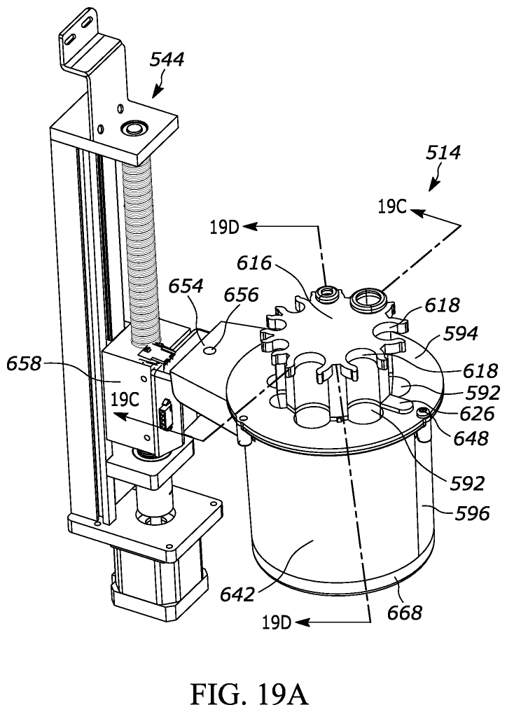

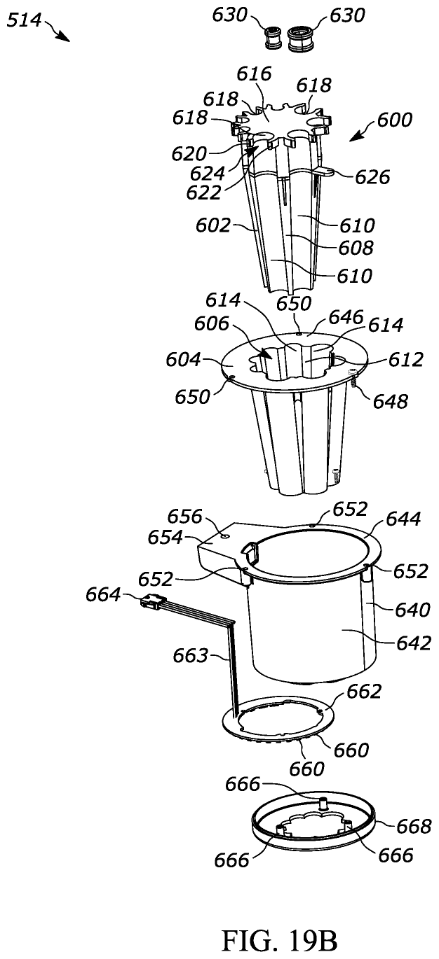

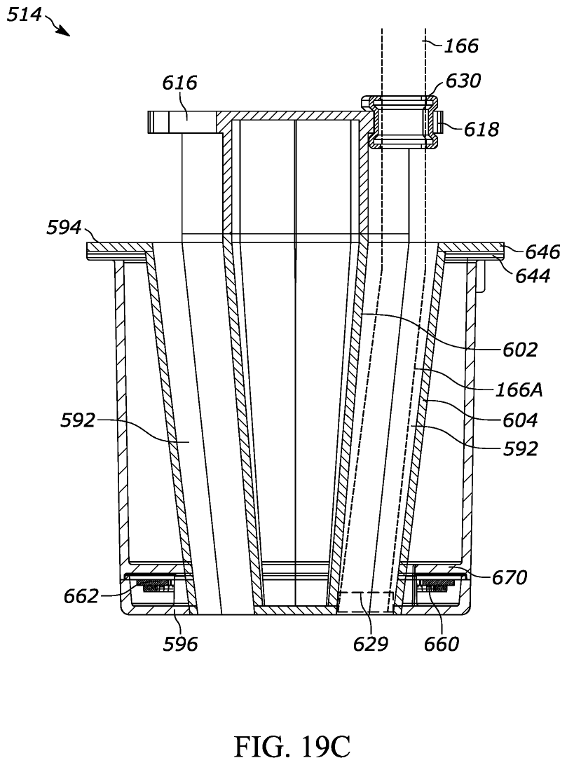

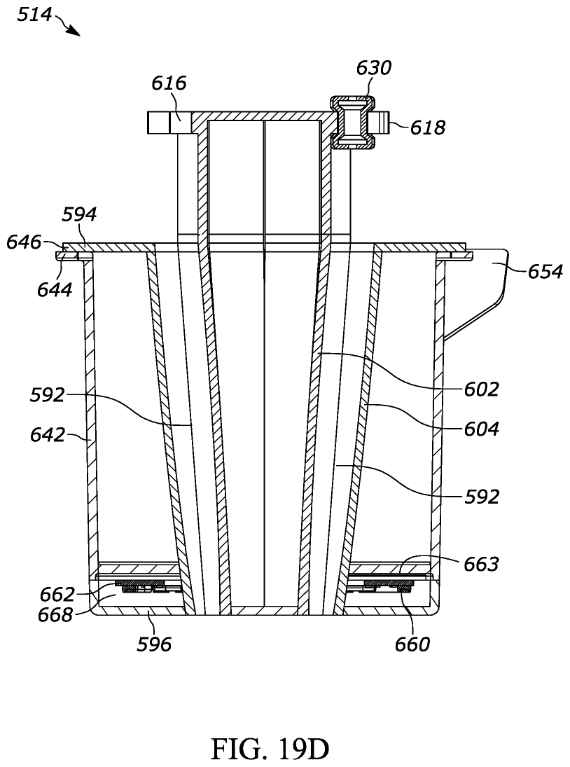

With respect to FIGS. 19A-19D, the dispenser head 514 is mounted to a lift system 544. The lift system 544 may be operated to raise or lower the dispensing head 514 as described above with respect to the previous embodiments. The dispensing head 514 has several passages 592 that extend from an inlet end 594 to an outlet end 596. Tubes 166 may be inserted into the passages 592 of the dispensing head 514 to hold and orient the end portion of the tubes 166 for dispensing into a single location (e.g., into a cup 112). The tubes may extend along the passages 592 from the inlet end 594 to the outlet end 596 of the dispensing head 514. For example, the tubes 166 may extend along the entire length of the passages 592. Condiment may be pumped through the tubes 166 and out an end of the tube 166 to be dispensed from the dispensing head 514 (e.g., into the cup 112). The condiment may thus be directly transferred from the tube 166 to the cup 112 without coming into contact with the passages 592 of the dispensing head 514. The tube 166 thus may form the entire flow path from the condiment pouch to the cup 112 which limits the components the condiment comes into contact with. This increases the cleanability of the condiment dispenser 500 as only the tube 166 may need to be cleaned or replaced to provide a clean flow path for the condiment.

The dispensing head 514 includes a multi-piece body 600 defining the passages 592 that may be separated, for example, for installing the tubes 166 and/or cleaning. The body 600 includes an inner body 602 and an outer body 604 that extend from the inlet end 594 toward the outlet end 596. The outer body 604 defines a central opening 606 (see FIG. 19B) to receive the inner body 602. The inner body 602 has an outer surface 608 including a plurality of grooves 610 that extend from the inlet end 594 toward the outlet end 596. The outer body 604 has an inner surface 612 defining the central opening 606 that include a plurality of grooves 614 that extend from the inlet end 594 toward the outlet end 596. The plurality of grooves 610 of the inner body 602 correspond to the plurality of grooves 614 of the outer body 604 such that when the inner body 602 is mated with the outer body 604, the grooves 610, 614 together form the passages 592 for the tubes 166. For example, the grooves 610 of the inner body 602 may be aligned with the opposing grooves 614 of the outer body 604 and the inner body 602 inserted into the central opening 606 of the outer body 604 to form the passages 592.

Separation of the inner body 602 and outer body 604 may make it easier to position the ends of the tubes 166 in the passages 592 of the dispensing head 514. For example, the tubes 166 may be positioned along the grooves 614 of the outer body 604 with the inner body 602 at least partially withdrawn from the outer body 604. Once the tubes 166 are positioned in the outer body 604, the inner body 602 may be inserted into the outer body 604 to form the passages 592 about the tubes 166. Insertion of the inner body 602 into the outer body 604 may compress the tubes 166 slightly such that the passages 592 are in frictional engagement with the tubes 166 to inhibit the tubes 166 from being withdrawn from the dispensing head 514. The inner body and outer body 604 may also be separated to provide access to the entire length of the passages 592, making it easier to clean the passages 592 (e.g., due to spillage). In some forms, the inner body 602 and outer body 604 are formed of a dishwasher safe material and may be easily separated and placed in a dishwasher. With the walls of the passages 592 exposed, the dishwasher is better able to clean along the entire length of the passages 592.

The inner body 602 may taper from the inlet end 594 to the outlet end 596. The inner surface 612 of the outer body 604 (and thus the central opening 606) may have a corresponding taper from the inlet end 594 to the outlet end 596. Thus, when inserting the inner body 602 into the outer body 604, the axial movement of the inner body 602 is limited by the tapered shape of the outer body 604. The inner body 602 may also be wedged into the outer body 604 to be held in place by a friction fit. In some forms, the outer body 604 is made of a plastic material and the inner body 602 is made of an elastomeric material (e.g., silicone or rubber). The inner body 602 may thus compress against the outer body 604 upon insertion to form a tight connection with the outer body 604 between the passages 592.

The inward taper of the inner flow body 602 and outer body 604 forms passages 592 that angle inward toward one another as they extend from the inlet end 594 toward the outlet end 596. The passages 592 hold the tubes 166 installed in the passages 592 at an angle to direct condiment dispensed from the tubes 166 to a central point (e.g., in the cup 112). This ensures the condiment is dispensed into the cup 112 and limits splatter outside of the cup 112. The passages 592 and thus the tubes 166 have a higher concentration at the outlet end 596 than at the inlet end 594 of the dispensing head 514.

The inner body 602 may include a tab 626. The tab 626 may extend outward such that a user may grasp the tab 626 to pull the inner body 602 out of the outer body 604 to separate the components, for example, for removal or installation of the tubes 166.

The inner body 602 may include a tube connector 616 at the inlet end 594. The tube connector 616 includes a plurality of tube receivers 618 to connect the tubes to the dispensing head 514. Each tube receiver 618 includes opposing arms 620, 622 (see FIG. 19B) that receive the tube therebetween to secure the tube to the dispensing head 514. For example, the opposing arms 620, 622 may be arcuate to form an opening therebetween to receive the tube. The tube 166 may be passed through a grommet 630 that is to be received between the arms 620, 622 as illustrated in FIG. 19C. The arms 620, 622 may form an opening having diameter that is approximately the same as the grommet 630 to be received therein. For example, some of the tube receivers 618 may be sized to receive smaller diameter tubes of the flavorings while others of the tube receivers 618 are sized to receive large diameter tubes of the base condiments. The terminal ends of the opposing arms 620, 622 may be separated by a gap 624 that is smaller than the diameter of the grommet 630. To secure the tube to the dispensing head 514, the tube and grommet 630 are urged through the gap 624 and into the opening between the opposing arms 620, 622. As force is required to pass the grommet 630 and tube through the gap 624, the arms 620, 622 thus retain the tube therebetween and secure the tube to the dispensing head 514. The arms 620, 622 may apply an inward force on the grommet 630 that urges the grommet 630 against the tube to inhibit the tube from moving axially through the grommet 630. A grommet 630 may be used with some or all of the tubes to be connected to the respective tube receivers 618. In some forms, some or all of the tubes do not include a grommet 630 but instead are received directly into the tube receiver 618. The tubes may be flexible such that they compress when passing through the gap 624 and expand when in the opening between the opposing arms 620, 622 of the tube receiver 618 such that force is required to pass the tube back through the gap 624.

As shown in FIG. 19C, the end 166A of the tube 166 may be extended into the corresponding passage 592 of the dispensing head 514 (e.g., before attaching the tube to the tube receiver 618). A valve 629 may be mounted at the ends 166A of each of the tubes 166. The valve 629 may be a one-way valve that permits fluid to flow out of the tube 166 and into the passage 592. As one example, the valve 629 may be a cross-slit valve (e.g., X-slit) that is urged open by the pressure applied to the condiment by the pumps 522.

The dispensing head 514 may further include a support body 640 about the flow body 600. The support body 640 connects the dispensing head 514 to the lift system 544 and aids to inhibit contact with the body 600 (e.g., the outlet ends of the passages 592 and tubes 166) to inhibit contamination when a user of the condiment dispenser 500 inadvertently contacts the dispensing head 514. The support body 640 includes an outer wall 642 that extends about the body 600 of the dispensing head 514. The outer wall 642 may extend axially from the inlet end 594 to the outlet end 596. The support body 420 may include a support flange 644 extending from the inlet end of the outer wall 642. The outer body 604 may include a flange 646 that rests on the support flange 644 of the support body 640 when the outer body 604 is inserted into the support body 640. The support body 640 thus supports the flow body 600. Fasteners 648 may be extended through openings 650 of the flange 646 of the outer body 604 and into openings 652 of the support flange 644 to secure the outer body 604 to the support body 640. In other forms, the outer body 604 may be secured to the support body 640 with a clip system, for example, such that the components can be easily separated (e.g., without tools) for cleaning.

The support body 640 includes an attachment arm 654. The attachment arm 654 may be connected to the lift system 544 to secure the dispensing head 514 to the lift system 544 such that the lift system 544 is able to raise and lower the dispensing head 514. The attachment arm 654 may be removably connectable to the lift system 544 to permit the dispensing head 514 to be disconnected from the lift system 544, e.g., for cleaning. The attachment arm 654 may include an opening 656 into which a fastener (e.g., a screw) may be extended to connect the attachment arm 654 to the trolley 658 of the lift system 544.

The dispensing head 514 may include lights such as LEDs 660. The LEDS 660 may be mounted at the outlet end 596 of the dispensing head 514. The LEDs 660 may be part of the user interface of the condiment dispenser 500 and be illuminated in various colors or flashing patterns, for example, to indicate to the user when the condiment dispenser 500 is dispensing condiment and when the user can take their cup 112. The LEDs 660 may be mounted to a printed circuit board (PCB) 662. A wiring harness 663 may extend from the PCB 662 to a connector 664 that is removably connectable to a connector of the condiment dispenser 500 (e.g., mounted on the trolley 658 of the lift system 544) to permit the processor of the condiment dispenser 500 to control the LEDs 660. In the form shown, the PCB 662 with the LEDs 660 are mounted to the outlet end 596 of the dispensing head 514. The PCB 662 may be mounted to an end of the support body 640, such as to the attachment wall 670 that extends radially inward from the outer wall 642. An end cap 668 may be removably secured to the support body 640 such that the PCB 662 is housed by the support body 640 and the end cap 668 (e.g., between the end cap 668 and the attachment wall 670 of the support body 640). For example, the end cap 668 includes openings 666 through which fasteners may be extended to attach the end cap 668 to the support body 640 to secure the PCB 662 at the end of the dispensing head 514. The end cap 668 may be clear or made of a translucent material (e.g., a plastic) to permit light emitted from the LEDs 660 to pass therethrough and be visible to a user. The wiring harness 663 may be routed upward through the dispensing head 514 in the space between the outer body 604 and the outer wall 642 to the attachment arm 654. The wiring harness 663 may extend out of the dispensing head 514 along the attachment arm 654 to be connected to the condiment dispenser 500 (e.g., a connector mounted to the trolley 658).

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

1. A condiment dispenser comprising:
a plurality of condiment supports each configured to position different types of condiment;
a dispensing head including a plurality of passages therethrough, each passage of the plurality of passages including an inlet end and an outlet end;
a condiment receptacle receiving portion positioned adjacent the outlet ends of the plurality of passages of the dispensing head, the condiment receptacle receiving portion for receiving a receptacle; and
a plurality of fluid transfer systems each connected to a condiment support of the plurality of condiment supports and a passage of the plurality of passages of the dispensing head, each fluid transfer system operable to transfer condiment from the condiment support to a corresponding passage of the dispensing head to dispense the condiment into the receptacle from the outlet end of the passage.

2. The condiment dispenser of claim 1 wherein the plurality of fluid transfer systems each include a tube connected to the associated condiment support and the corresponding passage of the dispensing head and a pump operable to pump condiment from the condiment support to the dispensing head.

3. The condiment dispenser of claim 2 wherein the pump is a peristaltic pump.

4. The condiment dispenser of claim 2 wherein each tube is removably connected to the corresponding passage of the dispensing head.

5. The condiment dispenser of claim 4 wherein each tube is removably connected to the dispensing head via a connector, the connector including a collar mounted to an end of the tube and having a recessed portion, the collar removably insertable into the inlet end of the corresponding passage, the dispensing head having a retractable pin associated with the passage, the pin extendable into the recessed portion of the collar to secure the tube to the dispensing head.

6. The condiment dispenser of claim 2 wherein the tube of each of the plurality of fluid transfer systems extends in the corresponding passage of the dispensing head from the inlet end to the outlet end.

7. The condiment dispenser of claim 1 wherein the outlet ends of the plurality of passages of the dispensing head are in closer proximity to one another than the inlet ends of the plurality of passages.

8. The condiment dispenser of claim 1 wherein the plurality of passages converge as the plurality of passages extend from the inlet ends to the outlet ends.

9. The condiment dispenser of claim 1 further comprising a linear actuator operable to move the dispensing head relative to the condiment receptacle receiving portion.

10. The condiment dispenser of claim 1 wherein the dispensing head includes an inner body and an outer body, the inner body reversibly mating with the outer body to define the plurality of passages therethrough.

11. The condiment dispenser of claim 10 wherein the outer body has an inner surface with a plurality of grooves and the inner body has an outer surface with a plurality of grooves that align with the plurality of grooves of the outer body to form the plurality of passages.

12. The condiment dispenser of claim 1 further comprising a plurality of weight sensors operable to measure the weight of each condiment support of the plurality of condiment supports.

13. The condiment dispenser of claim 12 wherein an amount of condiment dispensed by operation of a fluid transfer system of the plurality of fluid transfer systems is determined based at least in part on a change in measured weight of the corresponding condiment support.

14. The condiment dispenser of claim 12 wherein the plurality of weight sensors each include one or more weight plates and one or more load cells, the one or more weight plates being on the one or more load cells to transfer weight of the condiment support resting thereon to the one or more load cells.

15. A condiment dispenser comprising:
a plurality of condiment supports each configured to position different types of condiment;
a dispensing head including an inner body and an outer body, the inner body reversibly mating with the outer body to define a plurality of passages therethrough from an inlet end and an outlet end, each passage to receive one of the different types of condiment;
and a condiment receptacle receiving portion positioned adjacent the outlet end of the dispensing head.

16. The condiment dispenser of claim 15 wherein the outer body has an inner surface with a plurality of grooves and the inner body has an outer surface with a plurality of grooves that align with the plurality of grooves of the outer body to form the plurality of passages.

17. The condiment dispenser of claim 16 wherein at least a portion of the inner surface of the outer body and the outer surface of the inner body taper from the inlet end to the outlet end.

18. The condiment dispenser of claim 15 wherein the plurality of passages converge as the plurality of passages extend from the inlet end to the outlet end.

19. The condiment dispenser of claim 15 wherein the inlet end of the dispensing head includes a tube connector to secure tubes of the different types of condiment to the dispensing head.

20. The condiment dispenser of claim 19 wherein the tube connector includes a plurality of tube receivers corresponding to each passage of the plurality of passages, each tube receiver configured to secure a tube to the dispensing head to inhibit the tube from being withdrawn from one of the plurality of passages.

21. The condiment dispenser of claim 15 further comprising an attachment arm connecting the dispensing head to a lift system operable to move the dispensing head relative to the condiment receptacle receiving portion.

22. The condiment dispenser of claim 15 further comprising at least one indicator light mounted to the dispensing head.

23.-34. (canceled)
